(19) United States
(12) Patent Application Publication
(10) Pub. No.: US 2020/0410074 A1
(43) Pub. Date: Dec. 31, 2020

(54) IDENTITY AUTHENTICATION METHOD AND APPARATUS, ELECTRONIC DEVICE, AND STORAGE MEDIUM

(71) Applicant: BEIJING SENSETIME TECHNOLOGY DEVELOPMENT CO., LTD., Beijing (CN)

(72) Inventors: Liangliang Dang, Beijing (CN); Rui Zhang, Beijing (CN); Pan Huang, Beijing (CN); Liwei Wu, Beijing (CN); Penghui Chen, Beijing (CN); Mingyang Liang, Beijing (CN); Junjie Yan, Beijing (CN)

(21) Appl. No.: 17/015,509

(22) Filed: Sep. 9, 2020

Related U.S. Application Data
(63) Continuation of application No. PCT/CN2019/090034, filed on Jun. 4, 2019.

(30) Foreign Application Priority Data
Aug. 13, 2018 (CN) 201810918697.9
Aug. 13, 2018 (CN) 201810918699.8

(51) Int. Cl. G06F 21/32; G06F 21/33; G06K 9/00; G06K 9/62; G06K 9/32; G06F 16/535; G06N 3/08

(52) U.S. Cl. CPC G06F 21/32; G06F 21/33; G06K 9/00248; G06K 9/00268; G06N 3/08; G06K 9/00899; G06K 9/6215; G06K 9/325; G06F 16/535; G06K 9/00288

(57) ABSTRACT

An identity authentication method and apparatus, and a storage medium are provided. The identity authentication method includes: performing, by means of a first neural network, face detection on an image to be processed to obtain a face detection result, and performing, by means of a second neural network, document detection on the image to be processed to obtain a document detection result; determining whether the image to be processed is a valid identity authentication image according to the face detection result and the document detection result; and in response to determining that the image to be processed is a valid identity authentication image, performing identity authentication according to the face detection result and the document detection result to obtain an identity authentication result of the image to be processed.

### CROSS-REFERENCE TO RELATED APPLICATIONS

This application is a continuation of International Patent Application No. PCT/CN2019/090034, filed on Jun. 4, 2019, which claims priority to Chinese patent application No. 201810918697.9, filed on Aug. 13, 2018, and Chinese Patent Application No. 201810918699.8, filed on Aug. 13, 2018. The disclosures of International Patent Application No. PCT/CN2019/090034, Chinese patent application No. 201810918697.9, and Chinese Patent Application No. 201810918699.8 are hereby incorporated by reference in their entireties.

### BACKGROUND

At present, identity authentication on users is required in many fields of insurance, securities, finance and the like. According to a common method, an image acquisition device acquires a picture of a user holding an identity card in hand and uploads the picture of the user holding the identity card in hand to a server for manual verification in background on the server. Manually performing the identity verification on the acquired picture requires a lot of human resources, and is costly and inefficient. In addition, mistakes may occur during manual processing, the accuracy is relatively low, and cannot meet service requirements.

### SUMMARY

The disclosure relates to computer vision technologies, and particularly to an identity authentication method and apparatus, an electronic device, and a storage medium.

According to an aspect of the embodiments of the disclosure, an identity authentication method is provided, which may include that: face detection is performed on an image to be processed through a first neural network to obtain a face detection result, and certificate detection is performed on the image to be processed through a second neural network to obtain a certificate detection result; whether the image to be processed is a valid identity authentication image is determined according to the face detection result and the certificate detection result; and responsive to determining that the image to be processed is a valid identity authentication image, identity authentication is performed according to the face detection result and the certificate detection result to obtain an identity authentication result of the image to be processed.

According to a second aspect of the embodiments of the disclosure, an electronic device is provided, which may include: a processor and a memory configured to store instructions executable by the processor. The processor is configured to execute the instructions to implement the identity authentication method as described above in the disclosure.

According to another aspect of the embodiments of the disclosure, a computer-readable storage medium is provided, in which computer programs may be stored, where the computer program, when being executed by a processor, cause the processor to implement the identity authentication method as described above in the disclosure.

The technical solutions of the disclosure will further be described below through the drawings and the embodiments in detail.

### BRIEF DESCRIPTION OF THE DRAWINGS

The drawings, which constitute a part of the specification, describe the embodiments of the disclosure and together with the descriptions, serve to explain the principles of the disclosure.

Referring to the drawings, the disclosure may be understood more clearly according to the following detailed descriptions.

FIG. 1A is a flowchart of an identity authentication method according to an embodiment of the disclosure.

FIG. 1B is another flowchart of an identity authentication method according to an embodiment of the disclosure.

FIG. 2 is another flowchart of an identity authentication method according to an embodiment of the disclosure.

FIG. 3A is a schematic diagram of an example of an Application (APP) scenario according to an embodiment of the disclosure.

FIG. 3B is a schematic diagram of an acquired picture of a user holding an identity card in hand according to an embodiment of the disclosure.

FIG. 4 is a flowchart of an identity authentication method according to an embodiment of the disclosure.

FIG. 5 is a structure diagram of an identity authentication apparatus according to an embodiment of the disclosure.

FIG. 6 is another structure diagram of an identity authentication apparatus according to an embodiment of the disclosure.

FIG. 7 is another flowchart of an identity authentication method according to an embodiment of the disclosure.

FIG. 8 is another flowchart of an identity authentication method according to an embodiment of the disclosure.

FIG. 9 is another flowchart of an identity authentication method according to an embodiment of the disclosure.

FIG. 10 is a structural diagram of an identity authentication apparatus according to an embodiment of the disclosure.

FIG. 11 is another structural diagram of an identity authentication apparatus according to an embodiment of the disclosure.

FIG. 12 is an exemplary structural diagram of an electronic device according to an embodiment of the disclosure.

### DETAILED DESCRIPTION

Various exemplary embodiments of the disclosure will now be described with reference to the drawings in detail. It is to be noted that relative arrangement of components and operations, numeric expressions and numeric values set forth in these embodiments do not limit the scope of the disclosure, unless it is specifically stated otherwise. In addition, it is to be understood that, for convenience of description, the size of each part shown in the drawings is not drawn according to a practical proportional relationship. The following descriptions of at least one exemplary embodiment are only illustrative in fact and not intended to form any limit to the disclosure and application or use thereof. Technologies, methods and devices known to those of ordinary skill in the art may not be discussed in detail, but the technologies, the methods and the devices should be considered as a part of the specification as appropriate. It is to be noted that similar reference signs and letters represent similar terms in the following drawings and thus a certain term, once defined in a drawing, is not required to be further discussed in subsequent drawings.

The embodiments of the disclosure may be applied to an electronic device such as a terminal, a computer system and a server, which may be operational with numerous other universal or dedicated computing system environments or configurations. Examples of well-known terminals, computing systems, environments and/or configurations that can be suitable for use with the electronic device include, but not limited to, a Personal Computer (PC) system, a server computer system, a thin client, a thick client, a handheld or laptop device, a microprocessor-based system, a set-top box, a programmable consumer electronic product, a network PC, a microcomputer system, a large computer system, a distributed cloud computing technical environment including any abovementioned system, and the like.

The electronic device may be described in a general context of computer system executable instruction, such as program modules, being executed by a computer system. Generally, the program module may include routines, programs, target programs, components, logics, data structures and the like, which perform specific tasks or implement specific abstract data types. The computer system/server may be implemented in a distributed cloud computing environment where tasks are executed by remote processing devices that are linked through a communication network. In the distributed cloud computing environment, program modules may be located in both local and remote computer system including a storage device.

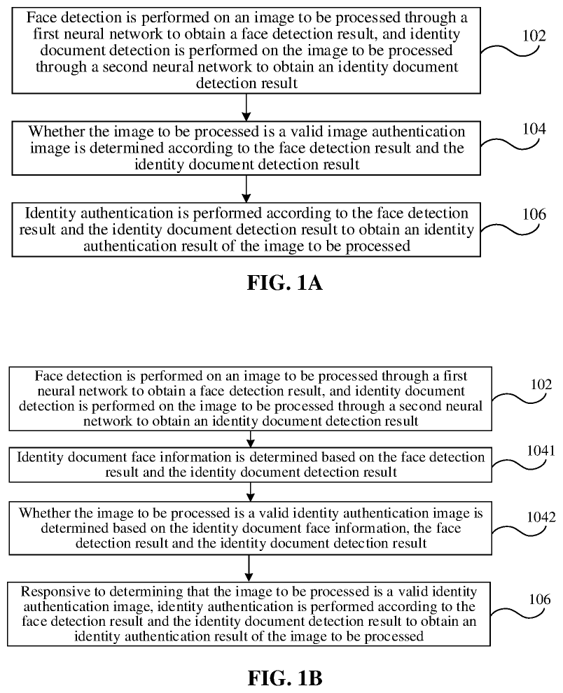

An embodiment of the disclosure provides an identity authentication method. As shown in FIG. 1A, the method includes the following operations.

In 102, face detection is performed on an image to be processed through a first neural network to obtain a face detection result, and certificate detection is performed on the image to be processed through a second neural network to obtain a certificate detection result.

In the embodiments of the disclosure, the image to be processed is an image acquired through a camera, or may be an image received from another device. The received image may be an acquired image and may also be obtained by performing one or more types of processing on the acquired image. In some embodiments, the image to be processed may be a static image (i.e., an image acquired independently), and may also be an image in a video (i.e., an image selected from the acquired video according to a preset standard or randomly). Both the static image and the image in the video may be adopted for identity authentication in the embodiments of the disclosure. All attributes of the image such as a source, a property and a size are not limited in the embodiments of the disclosure.

Those skilled in the art may know based on records in the embodiments of the disclosure that, besides the first neural network, an algorithm, for example, but not limited to, an image-processing-based face detection algorithm (for example, a histogram coarse segmentation and singular value feature-based face detection algorithm, a binary wavelet transform-based face detection algorithm or the like), may also be adopted to perform face detection on the image to be processed in the embodiments of the disclosure. In addition, besides the second neural network, an algorithm, for example, but not limited to, an image-processing-based certificate detection algorithm (for example, an edge detection method, a mathematical morphology method, a texture-analysis-based positioning method, a row detection and edge statistics method, a genetic algorithm, a Hough transform and outline method, a wavelet-transform-based method or the like), may also be adopted to perform certificate detection on the image to be processed in the embodiments of the disclosure.

In some embodiments, a position of a face in the image to be processed may be found by use of a face detection algorithm, and meanwhile, a position of a certificate in the image to be processed may be found by use of a certificate detection algorithm; and whether the image to be processed is a picture of holding an identity card in hand is determined based on a relationship between the found certificate position and face position. In this way, a worker may be helped to rapidly screen out a qualified image, and the working efficiency may be improved. In some other embodiments, if a face outside a certificate and a face inside the certificate are detected in the image to be processed, the two faces in the image to be processed may be compared to help the staff to rapidly determine whether the two faces in the image belong to the same person, for which the response time is short and real-time processing may be implemented, so that the working efficiency of the user is improved and the user experience is optimized; and meanwhile, the recognition accuracy of this method is higher than that of human eyes, and the staff is prevented from making mistakes.

In the embodiments of the disclosure, when face detection is performed on the image to be processed through the first neural network, the first neural network may be previously trained by use of sample images, so that the face in the image can be effectively detected through the trained first neural network. In the embodiments of the disclosure, when certificate detection is performed on the image to be processed through the second neural network, the second neural network may be previously trained by use of sample images, so that the certificate in the image can be effectively detected through the trained second neural network.

In some embodiments, the face detection result may include, but not limited to, for example, at least one of: the number of faces in the image to be processed, or position information of each of the faces in the image to be processed. The certificate detection result may include, but not limited to, for example, at least one of: the number of certificates in the image to be processed or position information of each of the certificates in the image to be processed. The position information of the face in the image to be processed may be represented as, for example, vertex coordinates of four vertexes of a face detection box (which may also be called a first detection box) of the face in the image to be processed. Based on the vertex coordinates of the four vertexes of the face detection box in the image to be processed, a position of the face detection box in the image to be processed may be determined, and thus a position of the face in the image to be processed is determined.

In addition, the position information of the face in the image to be processed may also be represented as a coordinate of a center point of the face detection box (i.e., the first detection box) of the face in the image to be processed, and a length and width of the face detection box. Based on the coordinate of the center point of the face detection box in the image to be processed and the length and width of the face detection box, the position of the face detection box in the image to be processed may be determined, and thus the position of the face in the image to be processed is determined.

In the embodiments of the disclosure, the certificate refers to an article configured to prove an identity of the user, for example, the identity card, a passport, a student card and an employee card. Similarly, the position information of the certificate in the image to be processed may be represented as, for example, vertex coordinates of four vertexes of an object detection box (which may also be called a second detection box) of the certificate in the image to be processed. Based on the vertex coordinates of the four vertexes of the object detection box in the image to be processed, a position of the object detection box of the certificate in the image to be processed may be determined, and thus a position of the certificate in the image to be processed is determined.

In addition, the position information of the certificate in the image may also be represented as a coordinate of a center point of the object detection box (i.e., the second detection box) of the certificate in the image to be processed, and a length and width of the object detection box. Based on the coordinate of the center point of the object detection box in the image to be processed and the length and width of the object detection box, the position of the object detection box of the certificate in the image to be processed may be determined, and thus the position of the certificate in the image to be processed is determined.

In 104, it is determined, according to the face detection result and the certificate detection result, whether the image to be processed is a valid image authentication image, for example, a valid image of holding an identity card in hand.

The valid identity authentication image refers to an image meeting a preset requirement, for example, an image to be processed of which positions and numbers of faces and certificates therein meet preset requirements. For example, in some implementation modes of the disclosure, if the required identity authentication image is a picture of the user holding the identity card in hand, the valid identity authentication image should include an identity card, a face is included in the identity card and at least one face is included outside the identity card. For example, if the total number of faces in both the face detection result and the certificate detection result is smaller than two, or the number of identity cards is not one, or verification for positions of the face and the identity card indicates an error (i.e., not as expected that the number of faces in an identity card region is one and there is at least one face outside the identity card region), it is considered that the image to be processed is not a valid identity authentication image (namely, the image to be processed is not a valid picture of holding an identity card in hand).

If the image to be processed is the valid identity authentication image, Operation 106 is executed. Otherwise, if the image to be processed is not the valid identity authentication image, a subsequent flow is not executed, or a prompt message indicating that the image to be processed is invalid is output.

In 106, identity authentication is performed according to the face detection result and the certificate detection result to obtain an identity authentication result of the image to be processed.

In some embodiments, identity authentication may include identity verification for determining whether the user is consistent with the certificate, namely determining whether the certificate is a certificate of the user per se. In some other embodiments, identity authentication may include anti-spoofing detection for determining whether there is spoofing. In some other embodiments, identity authentication may include anti-spoofing detection and identity verification. Specific implementation of identity authentication is not limited in the embodiments of the disclosure.

In some implementation modes, identity authentication is performed according to the face detection result and certificate detection result of the image to be processed by using a method including, but not limited to, for example, a geometric-feature-based method, local face analysis, Eigenface or Principal Component Analysis (PCA), an elastic-model-based method and a neural network.

Based on the identity authentication method provided in the embodiments of the disclosure, face detection is performed on the image to be processed through the first neural network, and certificate detection is performed on the image to be processed through the second neural network; whether the image to be processed is the valid identity authentication image is determined according to the obtained face detection result and certificate detection result; and responsive to determining that the image to be processed is the valid identity authentication image, identity authentication is performed according to the face detection result and the certificate detection result. According to the embodiments of the disclosure, whether the image to be processed is the valid identity authentication image or not is recognized by use of the neural networks in a deep learning manner, so that a qualified image for identity authentication of the user may be rapidly screened, and thus the working efficiency is improved. Identity of the user is authenticated based on the valid identity authentication image without manual verification, so that the cost is reduced, the working efficiency and the processing speed are improved; and moreover, errors that probably occur during manual verification processing are avoided, and the accuracy of the authentication result is improved.

In the abovementioned embodiments, the certificate detection result may include at least one of: the number of one or more faces in one or more certificates detected in the image to be processed, or the position information of the one or more faces in the one or more certificates, etc. Or, in the embodiments, the method may further include that: the number of the one or more faces in the one or more certificates is determined according to the position information of the one or more faces in the image to be processed in the face detection result and the position information of the one or more certificates in the image to be processed in the certificate detection result.

In some embodiments, in the operation 104, whether the number of certificates in the certificate detection result meets a first preset requirement, whether the number of faces in the face detection result meets a second preset requirement and whether the number of faces in the detected certificates meets a third preset requirement may be determined. Under a condition that the number of certificates in the certificate detection result meets the first preset requirement, the number of faces in the face detection result meets the second preset requirement and the number of faces in the detected certificates meets the third preset requirement, it may be determined that the image to be processed is the valid identity authentication image.

In the abovementioned embodiments, the number of the certificates in the certificate detection result meets the first preset requirement, the number of the faces in the face detection result meets the second preset requirement and the number of the faces in the certificates meets the third preset requirement may include, for example, that the number of the certificates in the certificate detection result is one, the number of the faces in the face detection result is greater than or equal to two and the number of the faces in the certificate is one. If the number of the faces in the face detection result is larger than two, it is indicated that the number of the faces outside a certificate region in the image to be processed may be larger than one, and in such case, besides a face of the authenticated user, the image to be processed may also include a face of a surrounding user.

Based on the above embodiments, if the number of the faces in the face detection result is smaller than two, the number of the certificates is not one or a position relationship between the face and the certificate is incorrect (the position relationship between the face and the certificate being correct is that the number of the faces in the certificate region is one and at least one face is included outside the certificate region), it is considered that the image to be processed is not the valid identity authentication image.

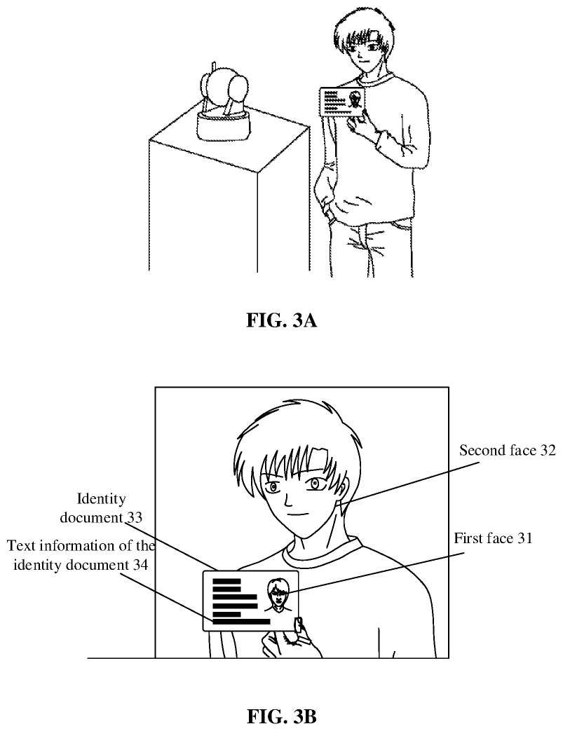

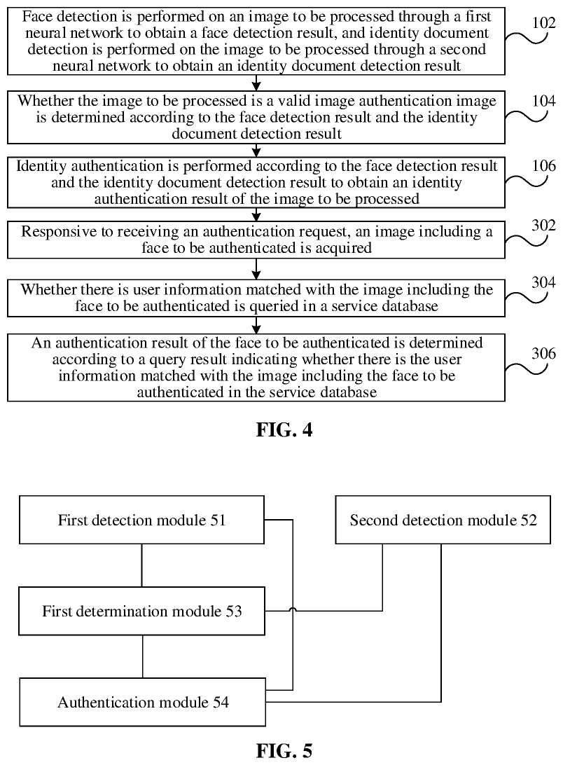

During an application, referring to FIG. 3A, an image acquisition device acquires a picture of the user holding the identity card in hand, which is as shown in FIG. 3B. Correspondingly, in Operation 106, the operation that identity authentication is performed according to the face detection result and the certificate detection result may include that: a similarity between a face (called a first face 31) in the certificate and a face (called a second face 32) outside the certificate in the image to be processed is determined based on the face detection result and the certificate detection result; and an identity verification result is obtained according to the similarity between the first face and the second face.

For example, in some optional examples, an image of the first face and an image of the second face may be obtained in the image to be processed based on the face detection result and the certificate detection result.

Feature extraction is performed on the image of the first face to obtain a first feature, and feature extraction is performed on the image of the second face to obtain a second feature. The second face is the largest face that is located outside the certificates in the image to be processed. In an optional example, feature extraction may be performed through a neural network to obtain the first feature and the second feature, and the similarity between the first face and the second face is determined based on the first feature and the second feature.

For example, the first feature and the second feature may be compared to obtain a similarity between the first feature and the second feature. In one optional example, the first feature and the second feature may be compared through the neural network to obtain the similarity; and the identity verification result may be obtained according to whether the similarity between the first feature and the second feature is greater than a preset threshold.

The preset threshold may be set according to practical requirements, for example, rigor of identity authentication over the user for a present service, performance of the first neural network and the second neural network, and an image acquisition environment, and may be regulated according to a change of the practical requirements. For example, for a financial service with a high security requirement, a requirement on the performance of the first neural network and the second neural network is relatively high, and the preset threshold may be set to be relatively high (for example, 98%), namely the image to be processed may pass identity authentication only when a similarity between the first feature and the second feature reaches over 98%, so as to ensure the security of the financial service. For a service of which a security requirement is not so high and an image acquisition environment is relatively poor, the preset threshold may be set to be relatively low (for example, 80%), namely the image to be processed may pass identity authentication when the similarity between the first feature and the second feature reaches over 80%, so as to simultaneously ensure the security of the service and the feasibility that identity of the user is authenticated based on the image to be processed in the service.

According to the embodiments of the disclosure, when feature extraction is performed on the image of the face in the certificate and the image of the face outside the certificate through the neural network and the extracted first feature and second feature are compared to obtain the similarity therebetween, the neural network may be pretrained to ensure that, through the trained neural network, feature extraction may be effectively performed on the image of the face in the certificate and the image of the face outside the certificate, and the similarity may be accurately obtained by comparison, so that whether the face in the certificate and the face outside the certificate are faces of the same person may be correctly recognized.

In some implementation modes of the above embodiments, before the similarity between the first face in the certificate and the second image outside the certificate in the image to be processed is determined, the second face may be acquired in the following manner.

Under the condition that the number of the faces in the image to be processed is larger than 2, the largest face outside the certificate in the at least two faces in the image to be processed is determined as the second face according to the position information of the faces in the image to be processed in the face detection result and the position information of the certificates in the image to be processed in the certificate detection result.

Under the condition that the number of the faces in the image to be processed is equal to two, the face outside the certificate in the two faces in the image to be processed is directly determined as the second face.

Under the condition that the number of the faces in the image to be processed is larger than two, the image to be processed may also include, besides the face of the authenticated user, the face of other surrounding users around the authenticated user. It may be considered that: the authenticated user is closest to the image acquisition device, and the face thereof is largest; and the surrounding user is farthest from the image acquisition device and the face thereof is smaller than the face of the authenticated user. According to the embodiments of the disclosure, feature extraction and similarity comparison are performed on the image of the face in the certificate and the image of the largest face outside the certificate by use of the neural network, so that whether the two faces belong to the same user or not may be effectively recognized, and thus to rapidly and accurately determine whether the two faces are faces of the same person, the response time is short, the accuracy is high, the working efficiency and the user experience may be effectively improved, and errors caused by recognition with human eyes may be avoided.

An embodiment of the disclosure provides an identity authentication method. As shown in FIG. 1B, the method includes the following operations.

In 102, face detection is performed on an image to be processed through a first neural network to obtain a face detection result, and certificate detection is performed on the image to be processed through a second neural network to obtain a certificate detection result.

In 1041, certificate face information is determined based on the face detection result and the certificate detection result.

In some embodiments, the face detection result includes at least one of: the number of one or more faces in the image to be processed or position information of the one or more faces in the image to be processed; and/or, the certificate detection result includes at least one of: the number of one or more certificates in the image to be processed or position information of the one or more certificates in the image to be processed.

In some embodiments, the certificate face information includes at least one of: the number of one or more faces in one or more certificates that are detected in the image to be processed and the position information of the one or more faces in the certificate.

The number of faces in one or more certificates is less than or equal to the number of faces in the image to be processed, and the position information of the one or more faces in the one or more certificates partially overlaps the position information of the one or more faces in the image to be processed, namely the position information of the one or more faces in the one or more certificates is a subset of the position information of the one or more faces in the image to be processed.

In 1042, whether the image to be processed is a valid identity authentication image is determined based on the certificate face information, the face detection result and the certificate detection result.

In 106, responsive to determining that the image to be processed is the valid identity authentication image, identity authentication is performed according to the face detection result and the certificate detection result to obtain an identity authentication result of the image to be processed.

The operations 1041 and 1042 in the embodiment provide an implementation mode of the operation 104 in the method shown in FIG. 1A.

In some embodiments, the operation that the certificate face information is determined based on the face detection result and the certificate detection result in 1041 includes the following operation.

The number of one or more faces and/or position information of the one or more faces in the certificate are/is determined according to the position information of the one or more faces in the image to be processed in the face detection result and the position information of the certificate in the image to be processed in the certificate detection result.

During an application, the position information of the faces in the image to be processed and the number of the faces in the image to be processed are determined at first. The position information of the faces in the image to be processed includes position information of faces in the certificates, and the number of the faces in the image to be processed includes the number of faces in the certificate. For example, the number of faces in the image to be processed is two, i.e., including a face 1 and a face 2, position information of the face 1 in the image to be processed is wz1, position information of the face 2 in the image to be processed is wz2, a position of the certificate in the image to be processed is wz3, and a range of the wz3 includes that of the wz2. In such case, it may be determined that the number of the faces in the certificate is 1 and the position information of the face in the certificate is wz2.

In some embodiments, the operation that whether the image to be processed is the valid identity authentication image or not is determined based on the certificate face information, the face detection result and the certificate detection result in 1042 includes the following operation.

Responsive to that the number of the certificates in the certificate detection result meets a first preset requirement, the number of the faces in the face detection result meets a second preset requirement and the number of the faces in the certificates in the certificate face information meets a third preset requirement, it is determined that the image to be processed is the valid identity authentication image.

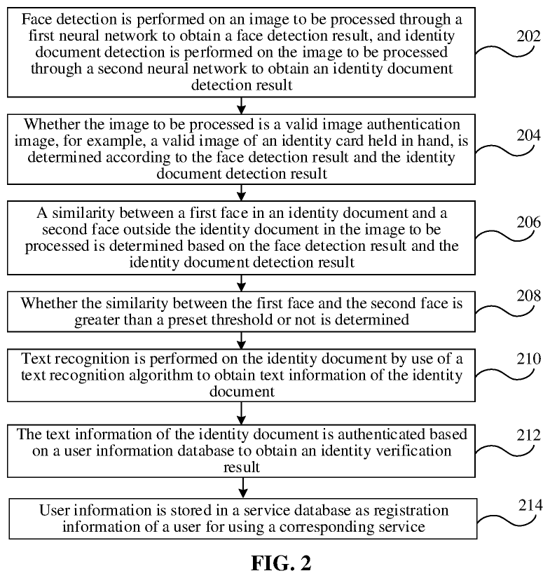

An embodiment of the disclosure provides another identity authentication method. As shown in FIG. 2, the method includes the following operations.

In 202, face detection is performed on an image to be processed through a first neural network to obtain a face detection result, and certificate detection is performed on the image to be processed through a second neural network to obtain a certificate detection result.

In 204, it is determined, according to the face detection result and the certificate detection result, whether the image to be processed is a valid image authentication image, for example, a valid image of holding an identity card in hand.

If the image to be processed is the valid identity authentication image, the operation 206 is executed. Otherwise, if the image to be processed is not the valid identity authentication image, a subsequent flow is not executed, or a prompt message indicating that the image to be processed is invalid is output.

In 206, a similarity between a first face in a certificate and a second face outside the certificate in the image to be processed is determined based on the face detection result and the certificate detection result.

In 208, whether the similarity between the first face and the second face is greater than a preset threshold is determined.

If the similarity between the first face and the second face is greater than the preset threshold, the operation 210 is executed. Otherwise, if the similarity between the first face and the second face is not greater than the preset threshold, a subsequent flow is not executed, or a prompt message indicating that the image to be processed does not pass identity authentication is output.

In some implementation modes, in the operations 206 and 208, feature extraction and similarity comparison may be performed on the first face in the certificate and the second face outside the certificate by use of a neural network, so as to confirm whether the first face and the second face outside the certificate are faces of the same user.

In 210, text recognition is performed on the certificate by use of a text recognition algorithm, for example, an Optical Character Recognition (OCR) algorithm, to obtain text information of the certificate. The text information may include, but not limited to, for example, any one or more of a name, a certificate number, an address and an expiration date.

Referring to FIG. 3B, an example of a valid identity authentication image in the embodiment of the disclosure is shown.

In some embodiments, text recognition is performed on a certificate 33 by use of the OCR algorithm, so that text information 34 of the certificate may be rapidly read; and a sheet may be automatically filled based on the text information, so that the working efficiency of customer service staff may be greatly improved, and the labor cost may be reduced. With adoption of face recognition and certificate OCR technologies, problems that identity of a user is authenticated by virtue of an identity card held in hand by the user in a conventional art may be effectively solved, and operations such as screening of a picture showing the identity card held in hand, comparison of two faces in a picture of holding the identity card in hand, extraction of identity card information and the like may be completed in real time.

Referring to FIG. 2 again, in some embodiments, after the text information of the certificate is obtained, the method may optionally further include the following operation.

In 212, the text information of the certificate is authenticated based on a user information database to obtain an identity verification result.

The user information database may be, for example, a user information database provided by the Ministry of Public Security or another certification authority having user information stored therein, to ensure the authority of a source of the user information source and the accuracy of the user information.

If the text information of the certificate is consistent with the user information stored in the user information database, the identity verification result indicates that identity authentication succeeds. Otherwise, if the text information of the certificate is inconsistent with the user information stored in the user information database, the identity verification result indicates that identity authentication fails.

In some embodiments, referring to FIG. 2 again, if the text information of the certificate passes identity authentication, the method may optionally further include the following operation.

In 214, user information is stored in a service database as registration information of the user to use a corresponding service. The user information may include any one or more of: text information of the certificate, an identity authentication image (i.e., the image to be processed that passes identity authentication), an image of the second face and feature information of the second face.

Based on the embodiments, after the registration information of the user is successfully stored, the user is successfully registered in the corresponding service, and then the user may use the service. The embodiments of the disclosure may be applied to any service requiring real-name authentication, for example, a transaction service, an APP usage service and an access control service. During use of the service, identify of the user is to be authenticated based on the user information in the service database, and the service may continue to be used only when the identity of the user passes identity authentication.

In some embodiments, anti-spoofing detection may further be performed on the image to be processed based on the face detection result and the certificate detection result to obtain an anti-spoofing detection result of the image to be processed. In such case, the identity authentication includes anti-spoofing detection and identity verification.

In some embodiments, anti-spoofing detection may be performed at first, and whether to perform identity verification or not is determined based on the anti-spoofing detection result. For example, responsive to that the anti-spoofing detection result indicates that anti-spoofing detection succeeds, identity verification is performed according to the face detection result and the certificate detection result. Otherwise, if the anti-spoofing detection result indicates that anti-spoofing detection fails, identity verification is not performed according to the face detection result and the certificate detection result.

In some other embodiments, anti-spoofing detection and identity verification may be executed in parallel, and an identity authentication result of the image to be processed is determined based on the anti-spoofing detection result and the identity verification result of the image to be processed.

In some embodiments, if the anti-spoofing detection result of the image to be processed indicates that anti-spoofing detection succeeds and the identity verification result indicates that identity verification succeeds, it is determined that the image to be processed passes identity authentication. Otherwise, if the anti-spoofing detection result of the image to be processed indicates that anti-spoofing detection fails and/or the identity verification result indicates that identity verification fails, it is determined that the image to be processed does not pass identity authentication.

In one optional example, the operation that anti-spoofing detection is performed according to the face detection result and the certificate detection result to obtain the anti-spoofing detection result includes that: a face region image and certificate region image are acquired from the image to be processed based on the face detection result and the certificate detection result; spoofing clue detection is performed on the image to be processed, the face region image and the certificate region image respectively; and the anti-spoofing detection result of the image to be processed is obtained based on a spoofing clue detection result.

In some embodiments, the operation that identity authentication is performed according to the face detection result and the certificate detection result to obtain the identity authentication result of the image to be processed further includes that: anti-spoofing detection is performed according to the face detection result and the certificate detection result to obtain an anti-spoofing detection result; and the identity authentication result of the image to be processed is determined based on the anti-spoofing detection result and the identity verification result.

In some embodiments, the operation that identity authentication is performed according to the face detection result and the certificate detection result to obtain the identity authentication result of the image to be processed includes that: anti-spoofing detection is performed according to the face detection result and the certificate detection result to obtain the anti-spoofing detection result.

In some embodiments, the operation that the anti-spoofing detection result of the image to be processed is obtained based on the spoofing clue detection result includes that: responsive to that the spoofing clue detection result indicates that all the image to be processed, the face region image and the certificate region image do not include any spoofing clue, it is determined that the anti-spoofing detection result of the image to be processed is that anti-spoofing detection succeeds; and/or, responsive to that the spoofing clue detection result indicates that any one or more of the image to be processed, the face region image and the certificate region image include a spoofing clue, it is determined that the anti-spoofing detection result of the image to be processed is that anti-spoofing detection fails.

In some embodiments, when spoofing clue detection is performed on the image to be processed, the face region image and the certificate region image respectively, feature extraction may be performed on the image to be processed, the face region image and the certificate region image to obtain the feature of the image to be processed, the feature of the face region image and the feature of the certificate region image respectively; and it is determined whether the feature of the image to be processed, the feature of the face region image and the feature of the certificate region image include the spoofing clue information.

In some implementation modes, when the spoofing clue information is detected from any of the feature of the image to be processed, the feature of the face region image and the feature of the certificate region image, it is determined that the anti-spoofing detection result of the image to be processed is that anti-spoofing detection fails; and when the spoofing clue information is not detected from all the feature of the image to be processed, the feature of the face region image and the feature of the certificate region image, it is determined that the anti-spoofing detection result of the image to be processed is that anti-spoofing detection succeeds.

In some optional examples, whether the feature of the image to be processed, the feature of the face region image and the feature of the certificate region image include the spoofing clue information may be detected in the following manner: the feature of the image to be processed is detected to determine whether the feature of the image to be processed includes the spoofing clue information; the feature of the face region image is detected to determine whether the feature of the face region image includes the spoofing clue information; and the feature of the certificate region image is detected to determine whether the feature of the certificate region image includes the spoofing clue information.

In some other optional examples, whether the feature of the image to be processed, the feature of the face region image and the feature of the certificate region image include the spoofing clue information may also be detected in the following manner: the feature of the image to be processed, the feature of the face region image and the feature of the certificate region image are connected to obtain a connected feature; and whether the connected feature includes the spoofing clue information is determined.

Exemplarily, the spoofing clue detection on the image to be processed, the face region image and the certificate region image respectively may be performed through a third neural network. For example, the image to be processed, the face region image and the certificate region image are input to the third neural network and processed respectively, to obtain probability information that the image to be processed, the face region image and the certificate region image each includes spoofing clue information, or indication information indicating whether the image to be processed, the face region image and the certificate region image each includes the spoofing clue information. For another example, the image to be processed, the face region image and the certificate region image are simultaneously input to the third neural network, where the third neural network includes three branches of feature extraction networks configured to perform feature extraction on the three input images respectively, connect the extracted features to obtain the connected feature, and obtain the probability information or indication information that the at least one image in the image to be processed, the face region image and the certificate region image includes spoofing clue information based on the connected feature.

Optionally, the third neural network is trained previously based on a training image set including the spoofing clue information. The third neural network may be a deep neural network, and the deep neural network refers to a multilayer neural network, for example, a multilayer convolutional neural network. Exemplarily, the spoofing clue information in each feature extracted in each embodiment of the disclosure may be learned by the third neural network through pre-training of the third neural network. Then, any image including the spoofing clue information, after being input to the third neural network, may be detected and determined as a fake image and cannot pass anti-spoofing detection, or otherwise an image not including the spoofing clue information is a real image and can pass anti-spoofing detection. In some embodiments, the training image set may include multiple images that may be used as positive samples for training and multiple images that may be used as negative samples for training. The positive sample image is a real image not including the spoofing clue information and may include the whole image as well as the feature of the face region image and certificate region image extracted from the whole image. The negative sample image is a fake image including the spoofing clue information.

In one optional example, the face region image and certificate region image may be acquired in the image to be processed according to the following requirements: a proportion of the face in the face region image with respect to the face region image meets a fourth preset requirement, and/or, a proportion of the certificate in the certificate region image with respect to the certificate region image meets the fourth preset requirement. The fourth preset requirement may include, for example, that the proportion of the face in the face region image with respect to the face region image and the proportion of the certificate in the certificate region image with respect to the certificate region image are more than or equal to ¼ and less than or equal to 9/10. For example, a value range of the proportion may be ½ to ¾. In some optional implementation modes, the value ranges of the proportion of the face in the face region image to the face region image and the proportion of the certificate in the certificate region image with respect to the certificate region image are ½ to ¾, so that the anti-spoofing detection efficiency may be improved under the condition that the anti-spoofing detection effect on the feature of the face region image and the certificate region image is ensured.

In an optional example, the training image set including the spoofing clue information may be acquired through the following method: the multiple images that may be used as the positive samples for training are acquired; and image processing for simulating the spoofing clue information is performed on a least part of at least one image in the acquired positive samples, to generate at least one image that may be used as a negative sample for training.

Based on the embodiments as mentioned above, anti-spoofing detection is performed on the image to be processed, so that identity authentication over the user with a fake face or certificate may be avoided, and the security of the identity authentication over the user is thereby improved.

Before the operations of the above embodiments, the method may further include the following operations. An image sequence or video sequence including the face and the certificate is acquired through, for example, a visible light camera of a terminal; and the image to be processed is selected from the image sequence or the video sequence based on a preset frame selection condition.

The preset frame selection condition may include, but not limited to, for example, any one or more of: whether the face and the certificate are located in a central region of the image, whether an edge of the face is completely included in the image, whether an edge of the certificate is completely included in the image, a proportion of the face in the image, a proportion of the certificate in the image, an angle of the face (namely whether the face is a front face), an image definition and an image exposure. An image with high comprehensive quality may be selected for identity authentication according to the frame selection condition, and therefore the accuracy of the identity authentication result may be improved.

Exemplarily, the image with the high comprehensive quality may be selected from the video sequence as the image to be processed based on the frame selection frame. A criterion for the image with the high comprehensive quality may be, for example, that the image meets any one or more of the following indicators: the face and the certificate are located in the central region of the image, the edge of the face and the certificate are completely included in the image, the proportion of the face in the image is about ½ to ¾, the proportion of the certificate in the image is about ½ to ¾, the face is a front face, the image definition is high and the exposure is high. For such selection, the indicators such as an orientation, definition, brightness of the face image may be automatically detected through a set algorithm, and one or more images with best indicators are selected from the whole video sequence according to a preset criterion.

In some optional implementation modes, the selected image to be processed that does not meet a preset criterion may also be preprocessed to obtain a preprocessed image to be processed. Correspondingly, identity authentication is performed for the preprocessed image to be processed.

Exemplarily, the preset criterion may include, but not limited to, for example, any one or more of: a preset size, a z-score distribution standard and preset image brightness. Correspondingly, preprocessing the image to be processed that does not meet the preset criterion may be: performing any one or more of the following operations corresponding to the preset criterion that is not met on the image to be processed not meeting the preset criterion: size regulation or cropping, z-score standardization, brightness regulation (for example, dark brightness improvement based on histogram equalization) and the like.

The preprocessing operations may be executed in a unified manner to subsequently process the size of the image to be processed and enable that the processed image data is submitted to a standard z-score distribution and the brightness meets a preset requirement. Z-score standardization is a statistical data processing method, through which pixel values in the image are processed to meet the standard z-score distribution, so as to eliminate the influence of non-uniform pixel distribution of the image on an image recognition effect. The preprocessing operation of dark brightness improvement based on histogram equalization is mainly for the condition that face and certificate are very likely to be dark in a practical scenario of anti-spoofing detection over the face and the certificate held in hand. Under this condition, the anti-spoofing accuracy of the face and the certificate is likely to be influenced. In the image obtained after dark brightness improvement, the brightness distribution of the whole image may be regulated to enable that the image originally shot under dark light may meet the requirement of image quality for identity authentication, thereby obtaining a more accurate identity authentication result.

As shown in FIG. 4, the identity authentication method based on some embodiments may further include the following operations.

In 302, responsive to receiving an authentication request, an image including a face to be authenticated is acquired.

In 304, whether there is user information in the service database matched with the image including the face to be authenticated is queried.

In some embodiments, in Operation 304, feature extraction may be performed on the image including the face to be authenticated by use of a neural network to query whether there is the user information in the service database matched with feature information of the face to be authenticated.

In 306, an authentication result of the face to be authenticated is determined according to a query result indicating whether there is the user information in the service database matched with the image including the face to be authenticated.

In some embodiments, according to the query result, if there is the user information matched with the feature information of the face to be authenticated in the service database, it is determined that the authentication result of the face to be authenticated is that authentication succeeds; otherwise, if there is no user information matched with the feature information of the face to be authenticated in the service database, it is determined that the authentication result of the face to be authenticated is that authentication fails.

Based on the embodiments, when the user is successfully registered in the corresponding service and during use of a service, the user requesting for using the service may be authenticated based on the registration information of the user, and the user may continue using the service only after passing authentication, so that the security of the service is improved.

In addition, optionally, in the embodiment shown in FIG. 4, after the image including the face to be authenticated is acquired in Operation 302, the method may further include the following operation that: anti-spoofing detection is performed on the image including the face to be authenticated to obtain an anti-spoofing detection result of the image including the face to be authenticated. Correspondingly, in Operation 306, the authentication result of the face to be authenticated is determined according to the query result indicating whether there is the user information in the service database matched with the feature information of the face to be authenticated and the anti-spoofing detection result indicating whether the image including the face to be authenticated passes anti-spoofing detection. In some embodiments, if there is the user information in the service database matched with the feature information of the face to be authenticated and the image including the face to be authenticated passes anti-spoofing detection, it is determined that the authentication result of the face to be authenticated is that authentication succeeds; otherwise, if there is no user information in the service database matched with the feature information of the face to be authenticated and/or the image including the face to be authenticated does not pass anti-spoofing detection, it is determined that the authentication result of the face to be authenticated is that authentication fails.

In some embodiments, anti-spoofing detection may be performed on the image including the face to be authenticated in a manner similar to that for performing anti-spoofing detection on an image including the face to be authenticated. For example, a face region image and certificate region image may be acquired from the image including the face to be authenticated; spoofing clue detection is performed on the image including the face to be authenticated, the face region image and the certificate region image respectively; and the anti-spoofing detection result of the image including the face to be authenticated is obtained based on a spoofing clue detection result.

When spoofing clue detection is performed on the image including the face to be authenticated, the face region image and the certificate region image respectively, feature extraction may be performed on the image including the face to be authenticated, the face region image and the certificate region image in a manner similar to that for performing anti-spoofing detection on the image including the face to be authenticated, to obtain a feature of the image including the face to be authenticated, a feature of the face region image and a feature of the certificate region image respectively. It is detected whether the feature of the image including the face to be authenticated, the feature of the face region image and the feature of the certificate region image include spoofing clue information.

Implementation of anti-spoofing detection over the image including the face to be authenticated in the embodiment of the disclosure may refer to the related records about anti-spoofing detection over the image including the face to be authenticated in the abovementioned embodiments, and will not be elaborated herein.

Based on the embodiments, anti-spoofing detection is performed on the image including the face to be authenticated, and the authentication result of the face to be authenticated is determined in combination with the anti-spoofing detection result of the image including the face to be authenticated, so that identity authentication over the user with the fake face or certificate may be avoided, and the security in use of the service is improved.

In some implementation modes of each embodiment of the disclosure, the feature extracted from the image to be processed or the image including the face to be authenticated, the face region image and the certificate region image may include, but not limited to, for example, any more of the following: an LBP feature, an HSC feature, a panorama (LARGE) feature, a face image (SMALL) feature and a face detail image (TINY) feature. During an application, feature items in the extracted feature may be updated according to spoofing clue information that may occur.

Edge information in the image may be highlighted through the LBP feature. Zero reflection and blurry information in the image may be reflected more obviously through the HSC feature. The LARGE feature is a full-image feature, and the most obvious spoofing clue (or hack) in the image may be extracted based on the LARGE feature. The face image (SMALL) is a regional segmented image in a size of few times (for example, 1.5 times) a face box in the image, which includes a face and a part for connecting the face and the background, and spoofing clues such as light reflection, a screen moire of a remake device and an edge of a model or a mask may be extracted based on the SMALL feature. The face detail image (TINY) is a regional segmented image in the size of the face box, which includes the face, and spoofing clues such as image PS (i.e., image edition based on image edition software photoshop), the screen moire of the copying device or a texture of the model or the mask may be extracted based on the TINY feature.

In an optional example of each embodiment of the disclosure, the spoofing clue information has a property of observability for human eyes under the visible light. That is, the spoofing clue information may be observed by the human eyes under the visible light. Based on the property of the spoofing clue information, it is possible to implement anti-spoofing detection on a static image or dynamic video acquired by use of a visible light camera (for example, a Red Green Blue (RGB) camera), and therefore additional introduction of a specific camera is avoided, and the hardware cost is reduced. The spoofing clue information may include, but not limited to, for example, any one or more of: spoofing clue information of an imaging medium, spoofing clue information of an imaging carrier and spoofing clue information of a real fake face. The spoofing clue information of the imaging medium is also called two-dimensional (2D) spoofing clue information, the spoofing clue information of the imaging carrier may also be called 2.5D spoofing clue information, and the spoofing clue information of the real fake face may also be called three-dimensional (3D) spoofing clue information. For example, the spoofing clue information required to be detected may be correspondingly updated according to a probable face fakes. By detecting the spoofing clue information, the electronic device may “discover” various boundaries between real faces and fake faces, and implement various types of anti-spoofing detection under the condition of a universal hardware device like the visible light camera, so that attacks from a fake face are prevented, and thus the security is improved.

The spoofing clue information of the imaging medium may include, but not limited to, for example, edge information, reflection information and/or material information of the imaging medium. The spoofing clue information of the imaging carrier may include, but not limited to, for example, a screen edge, screen refection and/or screen moire of a display device. The spoofing clue information of the real fake face may include, but not limited to, for example, a feature of a masked face, a feature of a model face and a feature of a sculpture face.

The spoofing clue information in the embodiment of the disclosure may be observed by the human eyes under the visible light. The spoofing clue information may be divided into 2D, 2.5D and 3D fake faces. The 2D fake face refers to a face image printed on a paper material, and the 2D spoofing clue information may include, for example, spoofing clue information such as an edge of the paper face, the paper material, paper reflection and the paper edge. The 2.5D fake face refers to a face image born by a carrier device such as the video copying device, and the 2.5D spoofing clue information may include, for example, spoofing clue information like the screen moire, screen glare and screen edge of the carrier device such as the video remake device. The 3D fake face refers to a real fake face, for example, a mask, a model, a sculpture and a 3D print, and the 3D fake face also has corresponding spoofing clue information, for example, spoofing clue information such as a seam of the mask and relatively abstract or excessively smooth skin of the model.

According to the embodiments of the disclosure, effective anti-spoofing detection under the visible light condition may be implemented independently of a special multi-spectrum device as well as a special hardware device, so that the hardware cost brought thereby is reduced, and the embodiments may be conveniently applied to various face detection scenarios and is particularly applied to a universal mobile APP.

Any identity authentication method provided in the embodiments of the disclosure may be executed by any proper electronic device with a data processing capability. Or, any identity authentication method provided in the embodiments of the disclosure may be executed by a processor. For example, the processor calls corresponding instructions stored in a memory to execute any identity authentication method mentioned in the embodiments of the disclosure. Elaborations are omitted hereinafter. Those of ordinary skill in the art should know that all or part of the operations (steps) of the method embodiments may be implemented by related hardware instructed through a program, the program may be stored in a computer-readable storage medium, and the program is executed to execute the operations of the method embodiment. The storage medium includes: various media capable of storing program codes such as a Read-Only Memory (ROM), a Random Access Memory (RAM), a magnetic disk or a compact disc.

An embodiment of the disclosure provides an identity authentication apparatus. In some embodiments, the apparatus may be configured to implement the above method embodiments, but the embodiment of the disclosure is not limited thereto. As shown in FIG. 5, the apparatus includes a first detection module 51, a second detection module 52, a first determination module 53 and an authentication module 54.

The first detection module 51 is configured to perform face detection on an image to be processed through a first neural network to obtain a face detection result. Optionally, the face detection result may include, but not limited to, for example, at least one of: the number of faces in the image to be processed or position information of the faces in the image to be processed. The position information of the faces in the image to be processed may be represented as, for example, vertex coordinates of four vertexes of a first detection box of the face in the image to be processed or a coordinate of a center point of the first detection box of the face in the image to be processed and a length and width of the face detection box.

The second detection module 52 is configured to perform certificate detection on the image to be processed through a second neural network to obtain a certificate detection result. Optionally, the certificate detection result may include, but not limited to, for example, at least one of: the number of certificates in the image to be processed and position information of the certificates in the image to be processed. The position information of the certificates in the image to be processed may be represented as, for example, vertex coordinates of a second detection box of the certificate in the image to be processed or a coordinate of a center of the second detection box of the certificate in the image to be processed and a length and width of the second detection box.

The first determination module 53 is configured to determine, according to the face detection result and the certificate detection result, whether the image to be processed is a valid image authentication image, for example, an image in which a certificate is held in hand.

The authentication module 54 is configured to, responsive to determining that the image to be processed is the valid identity authentication image, perform identity authentication according to the face detection result and the certificate detection result to obtain an identity authentication result of the image to be processed.

Based on the apparatus provided in the embodiment of the disclosure, face detection is performed on the image to be processed through the first neural network, and certificate detection is performed on the image to be processed through the second neural network; whether the image to be processed is the valid identity authentication image is determined according to the obtained face detection result and certificate detection result; and responsive to determining that the image to be processed is the valid identity authentication image, identity authentication is performed according to the face detection result and the certificate detection result. According to the embodiment of the disclosure, whether the image to be processed is the valid identity authentication image is recognized by use of the neural networks in a deep learning manner, so that a qualified image for identity authentication of a user may be rapidly screened, and thus the working efficiency is improved. Identity of the user is authenticated based on the valid identity authentication image without manual verification, so that the cost is reduced, the working efficiency and the processing speed are improved; and moreover, errors that probably occur during manual verification processing are avoided, and the accuracy of the authentication result is improved.

In some embodiments, the first determination module includes a certificate determination unit and an identity authentication determination unit.

The certificate determination unit is configured to determine certificate face information based on the face detection result and the certificate detection result.

The identity authentication determination unit is configured to determine whether the image to be processed is the valid identity authentication image based on the certificate face information, the face detection result and the certificate detection result.

In some embodiments, the certificate face information includes at least one of: the number of one or more faces in a certificate detected in the image to be processed or the position information of the one or more faces in the certificate.

In some embodiments, the certificate determination unit is configured to determine the number of one or more faces and/or position information of the one or more faces in the certificate according to the position information of the one or more faces in the image to be processed in the face detection result and the position information of the one or more certificates in the image to be processed in the certificate detection result.

In some embodiments, the certificate detection result may further include at least one of: the number of one or more faces in a certificate detected in the image to be processed and the position information of the one or more faces in the certificate, etc.

In some other embodiments, the first determination module may further be configured to determine the number of the faces in the certificate according to the number of the faces in the face detection result, the position information of the faces in the image to be processed in the face detection result and the position information of the certificate in the image to be processed in the certificate detection result.

In some embodiments, the first determination module is configured to, responsive to that the number of the certificates in the certificate detection result meets a first preset requirement, the number of the faces in the face detection result meets a second preset requirement and the number of the faces in the certificates in the certificate face information meets a third preset requirement, determine that the image to be processed is a valid identity authentication image.

The number of the certificates in the certificate detection result meeting the first preset requirement, the number of the faces in the face detection result meeting the second preset requirement and the number of the faces in the certificate meeting the third preset requirement may be, for example, that the number of the certificates in the certificate detection result is one, the number of the faces in the face detection result is more than or equal to two and the number of the faces in the detected certificate is one.

In some embodiments, the authentication module is configured to determine a similarity between a first face in a certificate and a second face outside the certificate in the image to be processed based on the face detection result and the certificate detection result; and obtain an identity verification result according to the similarity between the first face and the second face.

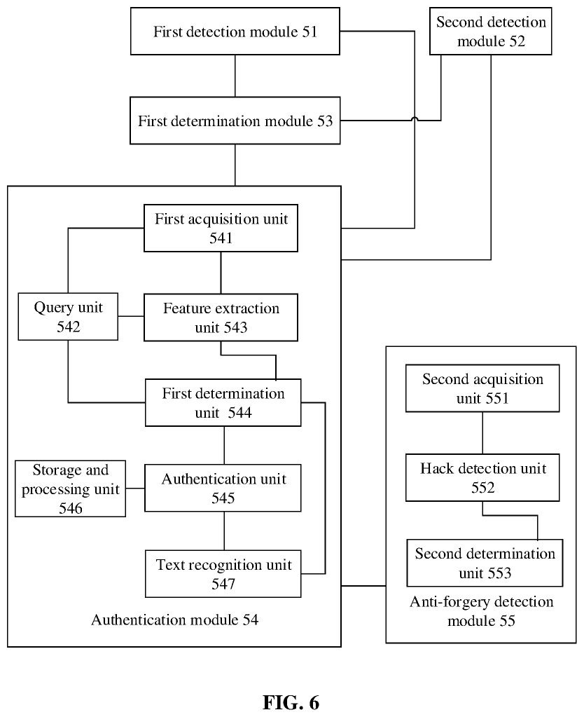

An embodiment of the disclosure provides another identity authentication apparatus. As shown in FIG. 6, compared with the structure shown in FIG. 5, in the structure shown in FIG. 6, the authentication module 54 includes: a first acquisition unit 541, configured to acquire an image of the first face and an image of the second face in the image to be processed based on the face detection result and the certificate detection result; a feature extraction unit 543, configured to perform feature extraction on the image of the first face to obtain a first feature and perform feature extraction on the image of the second face to obtain a second feature; a first determination unit 544, configured to determine the similarity between the first face and the second face based on the first feature and the second feature; and an authentication unit 545, configured to obtain the identity verification result according to the similarity between the first face and the second face.

In addition, referring to FIG. 6 again, the apparatus of the embodiments may further include a second determination module, configured to, under the condition that the number of the faces in the image to be processed is larger than two, determine the largest face outside the certificate in at least two faces in the image to be processed as the second face according to the position information of the faces in the image to be processed in the face detection result and the position information of the certificates in the image to be processed in the certificate detection result.

Moreover, referring to FIG. 6 again, in the apparatus of the embodiments, the authentication module may further include a text recognition unit 547, configured to, responsive to determining that the similarity between the first face and the second face is greater than a preset threshold, perform text recognition on the certificate to obtain text information of the certificate, the text information including at least one of a name or a certificate number. Correspondingly, the authentication unit 545 is further configured to authenticate the text information based on a user information database to obtain the identity verification result.

Further, referring to FIG. 6 again, in the apparatus of the embodiments, the authentication module may further include a storage and processing unit 546, configured to, responsive to determining that the identity authentication result is that identity authentication succeeds, store user information in a service database. The user information may include, but not limited to, for example, any one or more of the text information, the image to be processed, the image of the second face and feature information of the second face.

Furthermore, referring to FIG. 6 again, in the apparatus of the embodiment, the authentication module further includes a query unit 542. In the embodiment, the first acquisition unit 541 is further configured to, responsive to receiving an identity authentication request, acquire an image including a face to be authenticated. The query unit 542 is configured to query whether there is user information in the service database matched with the image including the face to be authenticated. The first determination unit 544 is further configured to determine an authentication result of the face to be authenticated according to a query result. Furthermore, referring to FIG. 6 again, in the apparatus of the embodiments, the authentication module 54 is further configured to perform anti-spoofing detection according to the face detection result and the certificate detection result to obtain an anti-spoofing detection result; and determine the identity authentication result of the image to be processed based on the anti-spoofing detection result and the identity verification result.

In some embodiments, the authentication module 54 is further configured to perform anti-spoofing detection according to the face detection result and the certificate detection result to obtain the anti-spoofing detection result.

In addition, referring to FIG. 6 again, in some embodiments, an anti-spoofing detection module 55 includes: a second acquisition unit 551, configured to acquire a face region image and certificate region image from the image to be processed based on the face detection result and the certificate detection result; a spoofing clue detection unit 552, configured to perform spoofing clue detection on the image to be processed, the face region image and the certificate region image respectively; and a second determination unit 553, configured to obtain the anti-spoofing detection result of the image to be processed based on a spoofing clue detection result.

A proportion of the face in the face region image with respect to the face region image meets a fourth preset requirement; and/or, a proportion of the certificate in the certificate region image with respect to the certificate region image meets the fourth preset requirement. The fourth preset requirement may be, for example, that the proportion is more than or equal to ¼ and less than or equal to 9/10.

In some embodiments, the second determination unit is configured to, responsive to that the spoofing clue detection result indicates that each of the image to be processed, the face region image and the certificate region image does not include a spoofing clue, determine that the anti-spoofing detection result of the image to be processed is that anti-spoofing detection succeeds, and/or, responsive to that the spoofing clue detection result indicates that any one or more of the image to be processed, the face region image and the certificate region image include a spoofing clue, determine that the anti-spoofing detection result of the image to be processed is that anti-spoofing detection fails.

In some embodiments, the spoofing clue detection unit is configured to perform feature extraction on the image to be processed, the face region image and the certificate region image to obtain a feature of the image to be processed, a feature of the face region image and a feature of the certificate region image respectively; and determine whether the feature of the image to be processed, the feature of the face region image and the feature of the certificate region image include the spoofing clue information.

In some embodiments, the extracted feature may include, but not limited to, for example, any one or more of an LBP feature, an HSC feature, a LARGE feature, a SMALL feature and a TINY feature.

In some embodiments, the spoofing clue information is observable by human eyes under visible light.

In some embodiments, the spoofing clue information may include, but not limited to, for example, any one or more of spoofing clue information of an imaging medium, spoofing clue information of an imaging carrier and spoofing clue information of a real fake face.

In some embodiments, the spoofing clue information of the imaging medium may include, but not limited to, for example, edge information, reflection information and/or material information of the imaging medium; the spoofing clue information of the imaging carrier may include, but not limited to, for example, a screen edge, screen reflection and/or screen moire of a display device; and/or, the spoofing clue information of the real fake face may include, but not limited to, for example, a feature of a masked face, a feature of a model face and a feature of a sculpture face.

In some embodiments, that the spoofing clue detection unit is configured to detect whether the feature of the image to be processed, the feature of the face region image and the feature of the certificate region image includes the spoofing clue information includes that: the spoofing clue detection unit is configured to detect the feature of the image to be processed to determine whether the feature of the image to be processed includes the spoofing clue information; detect the feature of the face region image to determine whether the feature of the face region image includes the spoofing clue information; and detect the feature of the certificate region image to determine whether the feature of the certificate region image includes the spoofing clue information.

In some embodiments, that the spoofing clue detection unit is configured to detect whether the feature of the image to be processed, the feature of the face region image and the feature of the certificate region image include the spoofing clue information includes that: the spoofing clue detection unit is configured to connect the feature of the image to be processed, the feature of the face region image and the feature of the certificate region image to obtain a connected feature; and determine whether the connected feature includes the spoofing clue information.

In some embodiments, that the spoofing clue detection unit is configured to perform spoofing clue detection on the image to be processed, the face region image and the certificate region image respectively includes that: the spoofing clue detection unit is configured to perform spoofing clue detection on the image to be processed, the face region image and the certificate region image through a third neural network respectively. In addition, an embodiment of the disclosure provides an electronic device, which includes: a memory, configured to store a computer program; and a processor, configured to execute the computer program stored in the memory, and implement, upon the computer program being executed, the identity authentication method of any embodiment of the disclosure.

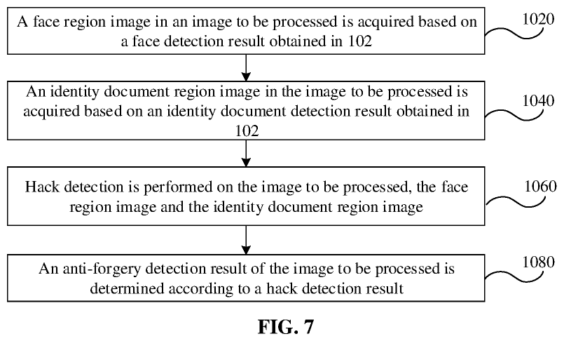

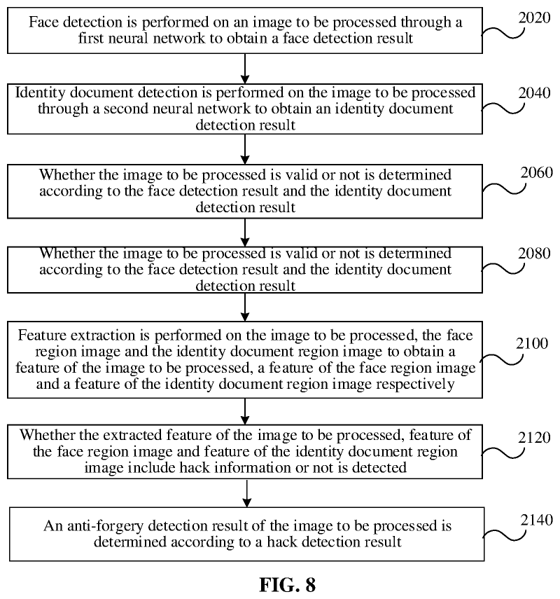

FIG. 7 is a flowchart of an identity authentication method according to an embodiment of the disclosure. As shown in FIG. 7, the method includes the following operations.

In 1020, a face region image is acquired from an image to be processed based on a face detection result obtained in 102.

In 1040, a certificate region image is acquired from the image to be processed based on a certificate detection result obtained in 102.

In 1060, spoofing clue detection is performed on the image to be processed, the face region image and the certificate region image.

In some embodiments, Operation 1060 may include that: feature extraction is performed on the image to be processed, the face region image and the certificate region image to obtain a feature of the image to be processed, a feature of the face region image and a feature of the certificate region image respectively; and it is detected whether the extracted feature of the image to be processed, feature of the face region image and feature of the certificate region image include spoofing clue information.

In some embodiments, the extracted feature, i.e., the extracted feature of the image to be processed, feature of the face region image and feature of the certificate region image, may include, but not limited to, for example, any more of the following: an LBP feature, an HSC feature, a LARGE feature, a SMALL feature and a TINY feature.

In 1080, an anti-spoofing detection result of the image to be processed is determined according to a spoofing clue detection result.

In some embodiments, in Operation 1080, under the condition that the spoofing clue detection result indicates that all the image to be processed, the face region image and the certificate region image do not include any spoofing clue information, it may be determined that the anti-spoofing detection result of the image to be processed is that anti-spoofing detection succeeds (which may be considered that identity authentication succeeds); and/or, under the condition that the spoofing clue detection result indicates that any one or more of the image to be processed, the face region image and the certificate region image include the spoofing clue information, it may be determined that the anti-spoofing detection result of the image to be processed is that anti-spoofing detection fails (which may be considered that identity authentication fails).

In some embodiments, identity authentication may include anti-spoofing detection and/or identity verification. The anti-spoofing detection (referring to the method shown in FIG. 7) is adopted to determine whether the image to be processed is spoofing. For example, an image synthesized by an image processing technology is a fake image, which may not pass the anti-spoofing detection. For another example, if the image is not a synthesized image but an image shot by a user holding a certificate in hand, the image may pass anti-spoofing detection. Identity verification (referring to the methods shown in FIGS. 1A, 1B and 2, etc.) is to determine whether a face (which may be considered as a face 1) in the image to be processed is consistent with a face (which may be considered as a face 2) in a certificate in the image to be processed, which in other words, is to determine whether the face 1 and the face 2 belong to the same person. In some embodiments, if identity authentication includes anti-spoofing detection and identity verification, identity authentication being successful includes that both the anti-spoofing detection and identity verification succeed. The anti-spoofing detection and identity verification may be executed in a random sequence, anti-spoofing detection may be performed before identity verification, or identity verification may be performed before anti-spoofing detection.

In a process of implementing the disclosure, it is found by the inventor that, when face anti-spoofing and certificate anti-spoofing detection technologies are adopted for identity authentication recognition at present, the face and the certificate are usually distinguished as two images for independent anti-spoofing detection. Such a detection manner has the following disadvantages that: it cannot be ensured that the certificate and the user are in the same time-space dimension; it is easy to obtain independent real face picture information and real certificate information and thus the reliability of a picture source may not be ensured; and the conditions that a real face holds a fake certificate and a fake face holds an authentic certificate is very likely to occur.

Based on the identity authentication method provided in the embodiment of the disclosure, the identity verification image including the face and the certificate is acquired, and the face region image and certificate region image are acquired in the image to be processed; spoofing clue detection is performed on the image to be processed, the face region image and the certificate region image; and the anti-spoofing detection result of the image to be processed is determined according to the spoofing clue detection result. The embodiment of the disclosure discloses a new anti-spoofing detection solution, which enables the face and the certificate to simultaneously appear in the same image, anti-spoofing detection is simultaneously performed on the face and the certificate, and the authenticity of the face and the certificate is simultaneously authenticated, so that a real person holds an authentic certificate is ensured. Therefore, various fake conditions such as a real face holding a fake certificate and a fake face holding an authentic certificate are prevented, and thereby the identity authentication reliability is improved.

In addition, before spoofing clue detection is performed on the image to be processed, the face region image and the certificate region image respectively in the operation 1060 of the embodiment, the method may further include the following operations. Face detection and certificate detection are performed on the image to be processed to obtain the face detection result and the certificate detection result respectively; and whether the image to be processed is valid is determined according to the face detection result and the certificate detection result. Correspondingly, the operation 1060 that spoofing clue detection is performed on the image to be processed, the face region image and the certificate region image may include that: responsive to determining that the image to be processed is valid, spoofing clue detection is performed on the image to be processed, the face region image and the certificate region image.

In some embodiments, the face detection result may include, but not limited to, for example, at least one of: the number of faces in the image to be processed and position information of each face in the image to be processed. The certificate detection result may include, but not limited to, for example, at least one of: the number of certificates in the image to be processed and position information of each certificate in the image to be processed.

The position information of the face in the image to be processed may be represented as, for example, vertex coordinates of four vertexes of a face detection box (which may also be called a first detection box) of the face in the image to be processed. Based on the vertex coordinates of the four vertexes of the face detection box in the image to be processed, a position of the face detection box in the image to be processed may be determined, thereby determining a position of the face in the image to be processed.

In addition, the position information of the face in the image to be processed may also be represented as a coordinate of a center point of the face detection box (i.e., the first detection box) of the face in the image to be processed and a length and width of the face detection box. Based on the coordinate of the center point of the face detection box in the image to be processed and the length and width of the face detection box, the position of the face detection box in the image to be processed may be determined, thereby determining the position of the face in the image to be processed.

In some embodiments, the operation that whether the image to be processed is valid is determined according to the face detection result and the certificate detection result may include that: whether the image to be processed is valid is determined according to whether the number of the faces in the image to be processed meets a first preset requirement, whether the number of the certificates in the image to be processed meets a second preset requirement and whether the number of the faces in the certificates meets a third preset requirement. Under the condition that the number of the faces in the image to be processed meets the first preset requirement, the number of the certificates in the image to be processed meets the second preset requirement and the number of the faces in the certificates meets the third preset requirement, it is determined that the image to be processed is valid.

In the above embodiments, the condition that the number of the faces in the image to be processed meets the first preset requirement may be, for example, that the number of the faces in the image to be processed is more than or equal to 2. The condition that the number of the certificates in the image to be processed meets the second preset requirement may be, for example, that the number of the certificates in the image to be processed is one. The condition that the number of the faces in the certificate meets the third preset requirement may be, for example, that the number of the faces in the certificate is one.

When the number of the faces in the image to be processed is larger than two, it is indicated that the number of the faces outside a certificate region in the image to be processed may be larger than one. In such case, besides a face of the authenticated user, the image to be processed may also include a face of an onlooker.

Based on the above embodiments, if the number of the faces in the image to be processed is smaller than two, the number of the certificates is not one or a position relationship between the faces and the certificate is incorrect (a standard for determining that the position relationship between the face and the certificate is correct is that the number of the faces in the certificate region is one and there is at least one face outside the certificate region), it is considered that the image is illegal and not a valid image to be processed.

Based on the embodiments of the disclosure, face detection and certificate detection are performed on the image to be processed to obtain the face detection result and the certificate detection result respectively, and whether the image to be processed is valid or not is determined according to the face detection result and the certificate detection result, so that a qualified image for identity authentication of the user may be rapidly screened, and the working efficiency is improved. Identity of the user is authenticated based on the valid image to be processed without manual verification, so that the cost is reduced, the working efficiency and the processing speed are improved; moreover, errors that probably occur during manual verification processing are avoided, and the accuracy of the authentication result is improved. Responsive to determining that the image to be processed is valid, spoofing clue detection is performed on the image to be processed as well as the face region image and certificate region image therein, so that the anti-spoofing detection efficiency is improved.

In some embodiments, Operation 1020 may include that: a video sequence is acquired through, for example, a visible light camera of a terminal device; and the image to be processed is selected from the video sequence based on a preset frame selection condition.

In some embodiments, Operation 1020 may include that: an image to be detected or video to be detected, including a face and a certificate, collected by the visible light camera of the terminal device is acquired, and the image to be processed may be acquired from the image to be detected or video to be detected acquired by the visible light camera.

FIG. 8 is another flowchart of an identity authentication method according to an embodiment of the disclosure. As shown in FIG. 8, the method includes the following operations.

In 2020, face detection is performed on an image to be processed through a first neural network to obtain a face detection result.

In 2040, certificate detection is performed on the image to be processed through a second neural network to obtain a certificate detection result.

In 2060, it is determined whether the image to be processed is valid according to the face detection result and the certificate detection result.

If it is determined that the image to be processed is valid, Operation 2080 is executed. Otherwise, if it is determined that the image to be processed is invalid, a subsequent flow of the embodiment is not executed, or a prompt message indicating that the image to be processed is invalid is output.

In 2080, a face region image is acquired in the image to be processed based on the face detection result, and a certificate region image is acquired in the image to be processed based on the certificate detection result.

In one implementation mode, an image of a region where a certificate is located may be acquired in the image to be processed according to position information of the certificate in the certificate detection result, and the image of the region where the certificate is located is determined as the certificate region image; a second face outside the certificate in the image to be processed is determined according to position information of a face in the face detection result and the position information of the certificate in the certificate detection result; and an image of a region where the second face is located is acquired in the image to be processed based on position information of the second face in the face detection result, and the image of the region where the second face is located is determined as the face region image.

In one optional example, the face region image and certificate region image may be acquired in the image to be processed according to the following requirement: a proportion of the face in the face region image with respect to the face region image meets a fourth preset requirement, and/or, a proportion of the certificate in the certificate region image with respect to the certificate region image meets the fourth preset requirement.

In 2100, feature extraction is performed on the image to be processed, the face region image and the certificate region image respectively to obtain a feature of the image to be processed, a feature of the face region image and a feature of the certificate region image.

In 2120, whether the extracted feature of the image to be processed, feature of the face region image and feature of the certificate region image include spoofing clue information is detected.

In some embodiments, whether the feature of the image to be processed, the feature of the face region image and the feature of the certificate region image include the spoofing clue information may be detected in the following manner: the feature of the image to be processed is detected to determine whether the feature of the image to be processed includes the spoofing clue information; the feature of the face region image is detected to determine whether the feature of the face region image includes the spoofing clue information; and the feature of the certificate region image is detected to determine whether the feature of the certificate region image includes the spoofing clue information.

Exemplarily, in the abovementioned implementation mode, when it is detected whether the feature includes the spoofing clue information, three binary classifiers in a neural network may be adopted to correspondingly detect whether the feature of the image to be processed, the feature of the face region image and the feature of the certificate region image include the spoofing clue information, and output detection results respectively. That is, the neural network includes three binary classifiers, one classifier is adopted to determine whether the feature of the image to be processed includes the spoofing clue information and output a detection result, another classifier is adopted to determine whether the feature of the region where the face is located includes the spoofing clue information and output a detection result, and the third classifier is adopted to determine whether the feature of the region where the certificate is located includes the spoofing clue information and output a detection result. Correspondingly, a spoofing clue detection result is determined according to the detection results output by the three binary classifiers. If the detection result output by each of the three binary classifiers is that the spoofing clue information is not included, the spoofing clue detection result is determined to be that spoofing clue detection succeeds; otherwise, if the detection result output by any one or more binary classifiers in the three binary classifiers is that the spoofing clue information is included, the spoofing clue detection result is determined to be that spoofing clue detection fails.

In some other optional implementation modes, whether the feature of the image to be processed, the feature of the face region image and the feature of the certificate region image include the spoofing clue information may be detected in the following manner: the feature of the image to be processed, the feature of the face region image and the feature of the certificate region image are connected to obtain a connected feature; and whether the connected feature includes the spoofing clue information is determined.

Exemplarily, in the abovementioned implementation mode, when it is detected whether the feature includes the spoofing clue information, a binary classifier in the neural network may be adopted to detect whether the connected feature includes the spoofing clue information and output a detection result. Correspondingly, the spoofing clue detection result is determined according to the detection result output by the binary classifier. If the detection result output by the binary classifier is that the spoofing clue information is not included, the spoofing clue detection result is determined to be that spoofing clue detection succeeds; otherwise, if the detection result output by the binary classifier is that the spoofing clue information is included, the spoofing clue detection result is determined to be that spoofing clue detection fails.

In 2140, an anti-spoofing detection result of the image to be processed is determined according to a spoofing clue detection result.

In some embodiments, spoofing clue detection may be performed on the image to be processed, the face region image and the certificate region image through the neural network respectively. That is, Operations 2100 to 2120 may be implemented in the following manner: the image to be processed, the face region image and the certificate region image are input to the neural network, and the spoofing clue detection result configured to represent whether the feature of the image to be processed, the feature of the face region image and the feature of the certificate region image include the spoofing clue information is output through the neural network. The neural network is pretrained based on a training image set including the spoofing clue information.

The neural network of the embodiments of the disclosure may be a deep neural network, and the deep neural network refers to a multilayer neural network, for example, a multilayer convolutional neural network.

The training image set may include: multiple first images that may be used as training positive samples and include faces and certificates; and multiple second images that may be used as training negative samples. In an optional example, the training image set including the spoofing clue information may be acquired in the following manner.

The multiple first images that may be used as training positive samples are acquired.

Image processing for simulating the spoofing clue information is performed on at least one of: at least part of the first image, at least part of a region where the face is located in the first image, or at least part of a region where the certificate is located in the first image, to generate at least one second image that may be used as a training negative sample.

Based on the embodiments of the disclosure, modeling is performed through a high description capability of the deep neural network, and training is performed through a large volume of image set data for training; differences between real and fake multidimensional faces and certificates, which are observable by human eyes, are learned, whether the face is a living body or not is determined, and if the face part is a picture fake attack, the face may be determined to be a fake face according to reflection of the picture or an edge feature of the picture. In addition, a difference between a normal certificate and a fake certificate is learned, for example, recognizing a re-shoot handheld certificate and a certificate copy, and the condition of certificate picture PS may also be avoided. Therefore, problems about certificate anti-spoofing are solved by use of a deep learning framework; and moreover, a learning capability of the neural network is high, its performance may be improved in real time by supplementary training, and thus the neural network has strong extensibility, which enables to be updated according to a change of a practical requirement to rapidly implement anti-spoofing detection for a new fake condition. Therefore, the accuracy of the detection result may be effectively improved, and the accuracy of the anti-spoofing detection result is further improved.

In some implementation modes of the embodiment of the disclosure, the neural network includes a third neural network in the terminal device, namely the operation of performing spoofing clue detection on the image to be processed, the face region image and the certificate region image in the above embodiments is executed through the third neural network in the terminal device. Correspondingly, in the implementation mode, the terminal device may determine the anti-spoofing detection result of the image to be processed according to the spoofing clue detection result output by the third neural network. Exemplarily, the spoofing clue information in the features extracted in the embodiments of the disclosure may be learned by the third neural network after the third neural network is trained. Then, any image including the spoofing clue information, after input to the third neural network, may be detected and determined as a fake image, or otherwise an image not including the spoofing clue information is a real image.

In addition, in some other implementation modes of the embodiments of the disclosure, Operation 1020 or 2020 may include that: a server receives the image to be processed sent by the terminal device.

Correspondingly, in the other implementation modes, the neural network includes a fourth neural network in the server, namely the operation of performing spoofing clue detection on the image to be processed, the face region image and the certificate region image in the embodiments is executed through the fourth neural network in the server. Exemplarily, spoofing clues in the feature extracted in the embodiments of the disclosure may be learned by the fourth neural network after the fourth neural network is trained. Then, any image including the spoofing clue information, after input to the fourth neural network, may be detected and determined as a fake image, or otherwise an image not including the spoofing clue information is a real image.

In some optional examples based on the other implementation modes, Operation 1080 may include that: the server may determine the anti-spoofing detection result of the image to be processed according to the spoofing clue detection result output by the fourth neural network and return the anti-spoofing detection result of the image to be processed to the terminal device; or, the server may return the spoofing clue detection result output by the fourth neural network to the terminal device, and the terminal device determines the anti-spoofing detection result of the image to be processed according to the spoofing clue detection result output by the fourth neural network.

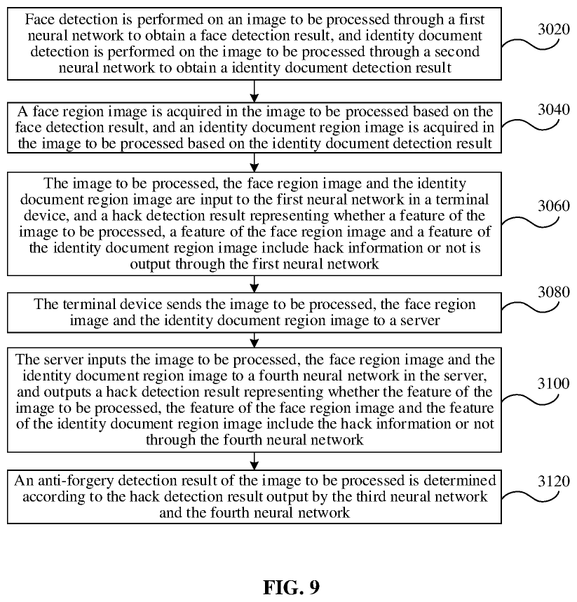

Or, in some other operational examples based on the other implementation modes, the neural network may further include the third neural network in the terminal device, where a size of the third neural network is smaller than a size of the fourth neural network. For example, the number of network layers and/or parameters of the third neural network may be smaller than that of the fourth neural network. As shown in FIG. 9, a flowchart of an identity authentication method according to an embodiment of the disclosure is shown. In the embodiment, for example, a neural network includes a third neural network in a terminal device and a fourth neural network in a server as an example. The method includes the following operations.

In 3020, face detection is performed on an image to be processed through a first neural network to obtain a face detection result, and certificate detection is performed on the image to be processed through a second neural network to obtain a certificate detection result.

In 3040, a face region image is acquired in the image to be processed based on the face detection result, and a certificate region image is acquired in the image to be processed based on the certificate detection result.

In 3060, the image to be processed, the face region image and the certificate region image are input to the third neural network in the terminal device, and a spoofing clue detection result representing whether a feature of the image to be processed, a feature of the face region image and a feature of the certificate region image include spoofing clue information or not is output through the third neural network.

In some embodiments, the third neural network may adopt the operations of the above implementation modes of the disclosure to extract the feature of the image to be processed, the feature of the face region image and the feature of the certificate region image and detect whether the extracted feature of the image to be processed, feature of the face region image and feature of the certificate region image include spoofing clue information to obtain the spoofing clue detection result.

According to the detection result output by the third neural network, if all the extracted features do not include any spoofing clue information, Operation 3080 is executed. Otherwise, if any one of the extracted features includes the spoofing clue information, Operation 3120 is executed.

In 3080, the terminal device sends the image to be processed, the face region image and the certificate region image to the server.

In 3100, the server inputs the image to be processed, the face region image and the certificate region image to the fourth neural network in the server, and outputs a spoofing clue detection result representing whether the feature of the image to be processed, the feature of the face region image and the feature of the certificate region image include the spoofing clue information through the fourth neural network.

In some embodiments, the fourth neural network may adopt the operations of the above implementation modes of the disclosure to extract the feature of the image to be processed, the feature of the face region image and the feature of the certificate region image and detect whether the extracted feature of the image to be processed, feature of the face region image and feature of the certificate region image include the spoofing clue information to obtain the spoofing clue detection result.

In 3120, an anti-spoofing detection result of the image to be processed is determined according to the spoofing clue detection result output by the third neural network and the fourth neural network.

If all the extracted features do not include any spoofing clue information according to the spoofing clue detection results output by the third neural network and the fourth neural network, it is determined that the image to be processed passes anti-spoofing detection. If the extracted features include the spoofing clue information according to the spoofing clue detection results output by the third neural network and/or the fourth neural network, it is determined that the image to be processed does not pass anti-spoofing detection.

In some embodiments, if the extracted features include the spoofing clue information according to the spoofing clue detection result output by the third neural network, it is determined that the image to be processed does not pass anti-spoofing detection of identity information. If the extracted features do not include any spoofing clue information according to the spoofing clue detection result output by the third neural network and the extracted features also do not include any spoofing clue information according to the spoofing clue detection result output by the fourth neural network, it is determined that the image to be processed passes anti-spoofing detection. If the extracted features do not include any spoofing clue information according to the spoofing clue detection result output by the third neural network, but the extracted features include the spoofing clue information according to the spoofing clue detection result output by the fourth neural network, it is determined that the image to be processed does not pass anti-spoofing detection.

In some embodiments, after the spoofing clue detection result is output through the fourth neural network in Operation 3100, the server may return the spoofing clue detection result output by the fourth neural network to the terminal device, and the terminal device executes Operation 3120, namely the terminal device determines the anti-spoofing detection result indicating whether the image to be processed passes anti-spoofing detection according to the spoofing clue detection result output by the fourth neural network.

In some other implementation modes, after the detection result is output through the fourth neural network in Operation 3100, the server may determine the anti-spoofing detection result indicating whether the image to be processed passes anti-spoofing detection according to the spoofing clue detection result output by the fourth neural network, and send a result indicating whether the image to be processed passes anti-spoofing detection to the terminal device.

Through Operation 3060, when the extracted features do not include any spoofing clue information according to the spoofing clue detection result output by the third neural network, the terminal device sends the image to be processed to the server, and Operation 3100 is executed through the fourth neural network. Therefore, in the implementation modes, whether the image to be processed passes anti-spoofing detection or not may directly be determined according to the spoofing clue detection result output by the fourth neural network. If the extracted features also do not include any spoofing clue information according to the spoofing clue detection result output by the fourth neural network, it is determined that the image to be processed passes anti-spoofing detection. If the extracted features include the spoofing clue information according to the spoofing clue detection result output by the fourth neural network, it is determined that the image to be processed does not pass anti-spoofing detection.

Since hardware performance of the terminal device is usually limited, the neural network that implements more feature extraction and detection requires more computing and storage resources, but computing and storage resources of the terminal device, compared with the cloud server, are relatively limited. Therefore, for saving computing and storage resources occupied by the neural network in a terminal device side and ensuring effective face anti-spoofing detection, in the embodiment of the disclosure, the terminal device is configured with a small (relatively shallow network and/or relatively few network parameters) third neural network, in which few features are integrated, for example, only an LBP feature and face SMALL feature are extracted from the image to be processed for corresponding spoofing clue information detection; and a cloud server with good hardware performance is configured with a large (i.e., relatively deep network and/or more network parameters) fourth neural network, in which comprehensive spoofing clue features are integrated to endow the fourth neural network with higher robustness and higher detection performance, and besides the LBP feature and the face SMALL feature are extracted from the image to be processed, other features probably including the spoofing clue information such as an HSC feature, a LARGE feature and a TINY feature may also be extracted. When the detection result output by the third neural network indicates that the spoofing clue information is not included, more accurate and comprehensive anti-spoofing detection is performed through the fourth neural network, so that the accuracy of the detection result is improved. When the detection result output by the third neural network indicates that the spoofing clue information is included, anti-spoofing detection is not required to be performed through the fourth neural network, so that the anti-spoofing detection efficiency is improved.

According to the embodiments of the disclosure, emphasis may be laid on detection of whether the image to be processed includes a spoofing clue (i.e., the spoofing clue information), and an approach almost without interaction is used to authenticate liveness, called silent living detection. The whole process of the silent living detection is substantially free of interaction, which greatly simplifies a living detection flow, in which a detected person only needs to directly face a video or image acquisition device (for example, a visible light camera) of the device where the neural network is located and light and a position are regulated, and any interactive action is unnecessary in the whole process. The neural network in the embodiment of the disclosure learns spoofing clue information that may be “observed” by human eyes in multiple dimensions in advance through a learning training method, and determines whether a face image is from a real living body during a subsequent application. If the image to be processed includes any spoofing clue information, the spoofing clue may be captured by the neural network, and then the user may be prompted that the face image is a fake face image. For example, for a fake face image in a remake video, screen reflection or screen edge feature in the image may be determined so as to determine that a face therein is a non-living body.

In the identity authentication method of another embodiment of the disclosure, the method may further include that: an identity authentication result of the image to be processed is determined according to the anti-spoofing detection result of the image to be processed.

In one example, under the condition that the image to be processed passes anti-spoofing detection, identity verification may be performed on the image to be processed, and the identity authentication result of the image to be processed may be determined based on an identity verification result.

In some implementation modes of the above embodiments, before identity authentication is performed on the user according to the face detection result and the certificate detection result, a second face may be acquired through the following manner.

Under the condition that the number of faces in the image to be processed is larger than two, the largest face, outside the certificate, in the at least two faces in the image to be processed is determined as the second face according to position information of the faces in the image to be processed in the face detection result and position information of the certificate in the image to be processed in the certificate detection result.

Under the condition that the number of faces in the image to be processed is two, a face outside the certificate in the two faces in the image to be processed is directly determined as the second face.

Under the condition that the number of the faces in the image to be processed is larger than two, the image to be processed may also include, besides the face of the authenticated user, a face of an onlooker. It may be considered that: the authenticated user is closest to the image acquisition device, and thus the face thereof is largest; and the onlooker is farthest from the image acquisition device, and thus the face is smaller than the face of the authenticated user. According to the embodiment of the disclosure, feature extraction and similarity comparison are performed on an image of the face in the certificate and an image of the largest face outside the certificate by use of the neural network, so that whether the two faces belong to the same user or not may be effectively recognized, and thus to rapidly and accurately determine whether the two faces are faces of the same person, the response time is short, the accuracy is high, the working efficiency and the user experience may be effectively improved, and errors caused by recognition with human eyes may be avoided.

In some optional examples, the operation that identity authentication is performed on the image to be processed may include that: a similarity between a first face in a certificate and a second face outside the certificate in the image to be processed is determined based on the face detection result of the image to be processed and the certificate detection result of the image to be processed; and the identity verification result is obtained according to the similarity between the first face and the second face.

For example, an image of the first face and an image of the second face processed may be acquired in the image to be; feature extraction is performed on the first face to obtain a first feature; feature extraction is performed on the second face to obtain a second feature; and the similarity between the first face and the second face is determined based on the first feature and the second feature.

In one optional example, through the third neural network, feature extraction is performed on the first face to obtain the first feature and feature extraction is performed on the second face to obtain the second feature; the similarity between the first feature and the second feature is determined based on the first feature and the second feature; and whether the image to be processed passes identity verification is determined according to whether the similarity between the first feature and the second feature is greater than a preset threshold, and as a result the identity verification result is obtained.

The preset threshold may be set according to a practical requirement, for example, rigor of identity authentication over the user for a present service, performance of the third neural network and an acquisition environment of the image to be processed, and may be regulated according to a change of the practical requirement.

According to the embodiment, when feature extraction is performed on the first face and the second face through the third neural network and the extracted first feature and second feature are compared to obtain their similarity, the third neural network may be pretrained to enable that, through the trained third neural network, feature extraction may be effectively performed on the first face in the certificate and the second face outside the certificate and the similarity between the extracted first feature and second feature may be accurately obtained by comparison. Therefore, whether the first face in the certificate and the second face outside the certificate are faces of the same person may be correctly recognized.

According to the embodiment, feature extraction and comparison may be performed on the first face in the certificate and the largest face outside the certificate, so as to rapidly and accurately determine whether they are faces of the same person, for which the response time is short and the accuracy is high, and thus the working efficiency and the user experience may be effectively improved, and errors caused by recognition with human eyes may be avoided.

In the embodiment, the face detection result includes at least one of the number of faces in the image to be processed and position information of the faces in the image to be processed; and/or, the certificate detection result includes at least one of the number of certificates in the image to be processed and position information of the certificates in the image to be processed. Correspondingly, in some implementation modes of the embodiment, before identity authentication is performed on the image to be processed, the second face may be acquired through the following manner.

Under the condition that the number of faces in the image to be processed is larger than 2, the largest face outside the certificate of the at least two faces in the image to be processed is determined as the second face according to the position information of the faces in the image to be processed in the face detection result and the position information of the certificate in the image to be processed in the certificate detection result.

Under the condition that the number of faces in the image to be processed is 2, a face outside the certificate of the two faces in the image to be processed is directly determined as the second face.

Under the condition that the number of the faces in the image to be processed is larger than 2, the image to be processed may also include the face of the onlooker, besides the face of the authenticated user. It may be considered that: the authenticated user is closest to the image acquisition device and thus the face thereof is largest; and the onlooker is farthest from the image acquisition device and thus the face thereof is smaller than the face of the authenticated user. According to the embodiment of the disclosure, feature extraction and similarity comparison are performed on an image of the face in the certificate and an image of the largest face outside the certificate by use of the neural network, so that whether the two faces belong to the same user or not may be effectively identified, and thus to rapidly and accurately determine whether the two faces are faces of the same person, for which the response time is short and the accuracy is high. As a result, the working efficiency and the user experience may be effectively improved, and errors caused by recognition with human eyes may be avoided.

In some embodiments, the operation that identity authentication is performed on the image to be processed in the abovementioned embodiment may further include that: responsive to determining that the similarity between the first face and the second face is greater than the preset threshold, text recognition is performed on the certificate by use of an OCR algorithm to obtain text information of the certificate, the text information including, but not limited to, for example, any one or more of a name, a certificate number, an address and an expiry date; and the text information is authenticated based on a user information database to obtain the identity verification result.

The user information database may be, for example, a user information database provided by the Ministry of Public Security or another certification authority, having information stored therein, to ensure the authority of a source of the user information source and the accuracy of the user information. If the text information of the certificate is consistent with the user information stored in the user information database, the identity verification result is that identity authentication succeeds. Otherwise, if the text information of the certificate is inconsistent with the user information stored in the user information database, the identity verification result is that identity authentication fails.

According to the embodiment, text recognition may be performed on the certificate by use of the OCR algorithm to rapidly read the text information in the certificate, and the text information may be authenticated based on the user information database to rapidly obtain the identity authentication result, so that the identity authentication efficiency is improved.

Based on the abovementioned embodiments, in various APPs, anti-spoofing detection and user identity verification may be performed based on the embodiments of the disclosure, and after both anti-spoofing detection and user identity verification succeed, a corresponding service that is requested may be used, so that the security in use of the service is improved. The embodiments of the disclosure may be applied to any service requiring real name authentication, for example, a payment service, an APP usage service and an access control service.

The embodiments of the disclosure may be applied to any of the following scenario requiring a user to holding a certificate (for example, an identity card) in hand for identity authentication.

In a first scenario, a user, when holding a certificate in hand for detection and further identity authentication, starts an APP for implementing the embodiments of the disclosure in a mobile terminal, faces a camera of the mobile terminal to ensure that a face and the certificate simultaneously appear in a picture and keeps this state for a few seconds, so that anti-spoofing detection through the certificate held in hand is completed and passed.

In a second scenario, the user uses a prepared video, such as a fake face holding a certificate in hand, for identity authentication. The user projects the video to a display screen and faces towards the camera of the mobile terminal, and if anti-spoofing detection of the face holding the certificate in hand cannot be passed in specified time, the anti-spoofing detection fails.

Any identity authentication method provided in the embodiments of the disclosure may be executed by any proper device with a data processing capability, including, but not limited to, a terminal device and a server. Or, any identity authentication method provided in the embodiments of the disclosure may be executed by a processor. For example, the processor is configured to execute any identity authentication method mentioned in the embodiment of the disclosure by invoking corresponding instructions stored in a memory. Elaborations are omitted hereinafter.

Those of ordinary skill in the art should know that all or part of the steps of the method embodiment may be implemented by related hardware instructed through a program, the program may be stored in a computer-readable storage medium, and the program is executed to execute the steps of the method embodiments. The storage medium includes: various media capable of storing program codes such as a ROM, a RAM, a magnetic disk or a compact disc.

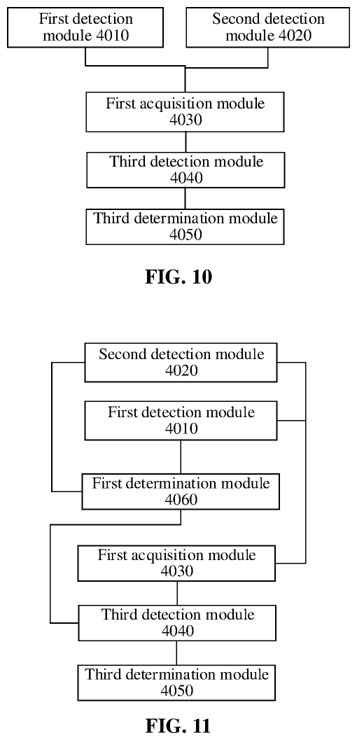

FIG. 10 is a structure diagram of an identity authentication apparatus according to an embodiment of the disclosure. The apparatus of the embodiment may be configured to implement the identity authentication method embodiments of the disclosure. As shown in FIG. 10, the apparatus of the embodiment includes a first detection module 4010, a second detection module 4020, a first acquisition module 4030, a third detection module 4040 and a third determination module 4050.

The first detection module 4010 is configured to perform face detection on an image to be processed through a first neural network to obtain a face detection result.

The second detection module 4020 is configured to perform certificate detection on the image to be processed through a second neural network to obtain a certificate detection result.

In some embodiments, the face detection result may include, but not limited to, for example, at least one of the number of faces in the image to be processed and position information of the faces in the image to be processed; and/or, the certificate detection result may include, but not limited to, for example, at least one of the number of certificates in the image to be processed and position information of the certificates in the image to be processed.

The first acquisition module 4030 is configured to acquire a face region image in the image to be processed based on the face detection result, and acquire a certificate region image in the image to be processed based on the certificate detection result.

The third detection module 4040 is configured to perform spoofing clue detection on the image to be processed, the face region image and the certificate region image.

The third determination module 4050 is configured to determine an anti-spoofing detection result of the image to be processed according to a spoofing clue detection result.

Based on the apparatus provided in the embodiments of the disclosure, the identity verification image including the face and the certificate is acquired, and the face region image and certificate region image are acquired from the image to be processed; spoofing clue detection is performed on the image to be processed, the face region image and the certificate region image; and the anti-spoofing detection result of the image to be processed is determined according to the spoofing clue detection result. The embodiment of the disclosure proposes a new solution for anti-spoofing detection of the image to be processed. The face and the certificate simultaneously appear in the same image, anti-spoofing detection is simultaneously performed on the face and the certificate and the authenticity of the face and the certificate is simultaneously authenticated, so as to ensure that a real person holds an authentic certificate. As a result, occurrence of various fake conditions such as a real face holds a fake certificate and a fake face holds an authentic certificate are prevented, and the identity authentication reliability is improved.

FIG. 11 is another structure diagram of an identity authentication apparatus according to an embodiment of the disclosure. As shown in FIG. 11, compared with the embodiment shown in FIG. 10, the apparatus of the embodiment may further include a first determination module 4060.

The first determination module 4060 is configured to determine whether the image to be processed is valid according to the face detection result and the certificate detection result. The third detection module 4040 may be configured to, responsive to determining that the image to be processed is valid, perform spoofing clue detection on the image to be processed, the face region image and the certificate region image.

In some embodiments, the apparatus may further include a second acquisition module, which may be configured to acquire a video sequence, and select the image to be processed from the video sequence based on a preset frame selection condition.

The preset frame selection condition may include, but not limited to, for example, any one or more of the following: whether the face and the certificate are located in a central region of the image, whether an edge of the face is completely included in the image, whether an edge of the certificate is completely included in the image, a proportion of the face in the image, a proportion of the certificate in the image, an angle of the face angle, an image definition and an image exposure.

In addition, the apparatus of the embodiment may further include a preprocessing module, configured to preprocess the image to be processed to obtain a preprocessed image to be processed. Correspondingly, the first detection module 4010 is configured to perform face detection on the preprocessed image to be processed through the first neural network to obtain the face detection result, and the second detection module 4020 is configured to perform certificate detection on the preprocessed image to be processed through the second neural network to obtain the certificate detection result. The first acquisition module 4030 may be configured to acquire a face region image in the preprocessed image to be processed based on the face detection result, and acquire a certificate region image in the preprocessed image to be processed based on the certificate detection result. The preprocessing may include, but not limited to, for example, any one or more of size regulation, image cropping, z-score standardization and brightness regulation.

In some embodiments, the first acquisition module 4030 may include: a third determination unit, configured to determine a second face outside the certificate in the image to be processed according to the position information of the faces in the face detection result and the position information of the certificates in the certificate detection result; and an acquisition unit, configured to acquire an image of a region where the second face is located in the image to be processed based on the position information of the second face in the face detection result and determine the image of the region where the second face is located as the face region image.

In addition, optionally, the first acquisition module 4030 may further include a fourth determination unit, configured to acquire an image of a region where the certificate is located in the image to be processed according to the position information of the certificates in the certificate detection result, and determine the image of the region where the certificate is located as the certificate region image.

In some embodiments, a proportion of the face in the face region image with respect to the face region image meets a fourth preset requirement; and/or, a proportion of the certificate in the certificate region image with respect to the certificate region image meets the fourth preset requirement. The fourth preset requirement may include, for example, that the proportion is more than or equal to ¼ and less than or equal to 9/10.

In some embodiments, the third detection module 4040 may include: an anti-spoofing feature extraction unit, configured to perform feature extraction on the image to be processed, the face region image and the certificate region image to obtain a feature of the image to be processed, a feature of the face region image and a feature of the certificate region image respectively; and a detection unit, configured to detect whether the feature of the image to be processed, the feature of the face region image and the feature of the certificate region image include spoofing clue information. In some embodiments, the extracted feature may include, but not limited to, for example, any one or more of an LBP feature, an HSC feature, a LARGE feature, a SMALL feature and a TINY feature.

In some embodiments, the spoofing clue information is observable by human eyes under visible light.

In some embodiments, the spoofing clue information includes any one or more of: spoofing clue information of an imaging medium, spoofing clue information of an imaging carrier and spoofing clue information of a real fake face.

In some embodiments, the spoofing clue information of the imaging medium includes edge information, reflection information and/or material information of the imaging medium; the spoofing clue information of the imaging carrier includes a screen edge, screen reflection and/or screen moire of a display device; and/or, the spoofing clue information of the real fake face includes a feature of a masked face, a feature of a model face and a feature of a sculpture face.

In some embodiments, the detection unit may be configured to detect the feature of the image to be processed to determine whether the feature of the image to be processed includes the spoofing clue information, detect the feature of the face region image to determine whether the feature of the face region image includes the spoofing clue information, and detect the feature of the certificate region image to determine whether the feature of the certificate region image includes the spoofing clue information.

In some other implementation modes, the detection unit may be configured to connect the feature of the image to be processed, the feature of the face region image and the feature of the certificate region image to obtain a connected feature, and determine whether the connected feature includes the spoofing clue information.

In some embodiments, the third detection module 4040 may be configured to perform spoofing clue detection on the image to be processed, the face region image and the certificate region image through a third neural network respectively.

In some embodiments, the third determination module may be configured to, under the condition that the spoofing clue detection result indicates that all the image to be processed, the face region image and the certificate region image do not include any spoofing clue, determine that the anti-spoofing detection result of the image to be processed is that anti-spoofing detection succeeds, and/or, under the condition that the spoofing clue detection result indicates that any one or more of the image to be processed, the face region image and the certificate region image include a spoofing clue, determine that the anti-spoofing detection result of the image to be processed is that anti-spoofing detection fails.

In some embodiments, the first detection module is arranged in a server, and may be configured to receive the image to be processed sent by a terminal device. In addition, the apparatus of the embodiment may further include a fourth determination module, configured to determine an identity authentication result of the image to be processed according to the anti-spoofing detection result of the image to be processed.

In some embodiments, the fourth determination module includes: an identity authentication unit, configured to, under the condition that the anti-spoofing detection result of the image to be processed is that anti-spoofing detection succeeds, perform identity verification on the image to be processed; and a fifth determination unit, configured to determine the identity authentication result of the image to be processed based on an identity verification result.

In some embodiments, the identity authentication unit may be configured to: determine a similarity between a first face in a certificate and a second face outside the certificate in the image to be processed based on the face detection result of the image to be processed and the certificate detection result of the image to be processed, and obtain the identity verification result according to the similarity between the first face and the second face.

In some embodiments, the identity authentication unit may be configured to: acquire an image of the first face and an image of the second face in the image to be processed; perform feature extraction on the image of the first face to obtain a first feature and perform feature extraction on the image of the second face to obtain a second feature; and determine the similarity between the first face and the second face based on the first feature and the second feature.

In some embodiments, the face detection result includes at least one of the number of faces in the image to be processed and position information of the faces in the image to be processed; and/or, the certificate detection result includes at least one of the number of certificates in the image to be processed and position information of the certificates in the image to be processed. Correspondingly, in the embodiment, the third determination module includes a third determination unit, configured to, under the condition that the number of the faces in the image to be processed is larger than two, determine the largest face outside the certificate in the at least two faces in the image to be processed as the second face according to the position information of the faces in the image to be processed in the face detection result and the position information of the certificates in the image to be processed in the certificate detection result.

In some embodiments, the identity authentication unit may further be configured to, responsive to determining that the similarity between the first face and the second face is greater than a preset threshold, perform text recognition on the certificate to obtain text information of the certificate, the text information including at least one of a name and a certificate number, and authenticate the text information based on a user information database to obtain the identity verification result.

In addition, an embodiment of the disclosure provides an electronic device, which includes a memory and a processor.

The memory is configured to store a computer program.

The processor is configured to execute the computer program stored in the memory, and implement, upon execution of the computer program, the identity authentication method of any embodiment of the disclosure.

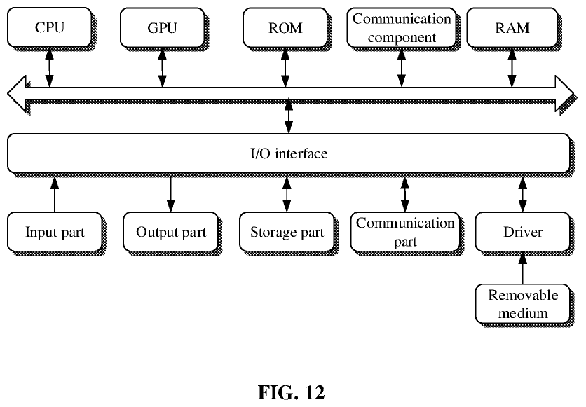

An embodiment of the disclosure provides an electronic device. Referring to FIG. 12, a structure diagram of an electronic device suitable for implementing a terminal or server according to an embodiment of the disclosure is shown. As shown in FIG. 12, the electronic device includes one or more processors, a communication unit and the like. The one or more processors are, for example, one or more Central Processing Units (CPUs) and/or one or more Graphics Processing Units (GPUs). The processor may execute various proper actions and processings according to an executable instruction stored in a ROM or an executable instruction loaded from a storage part 1508 to a RAM. The communication unit may include, but not limited to, a network card, and the network card may include, but not limited to, an Infiniband (IB) network card. The processor may communicate with the ROM and/or the RAM to execute the executable instruction, be connected with the communication unit through a bus and communicate with another target device through the communication unit, thereby completing the corresponding operations of any identity authentication method provided in the embodiments of the disclosure. For example, face detection is performed on an image to be processed through a first neural network to obtain a face detection result, and certificate detection is performed on the image to be processed through a second neural network to obtain a certificate detection result; whether the image to be processed is a valid identity authentication image or not is determined according to the face detection result and the certificate detection result; and responsive to determining that the image to be processed is the valid identity authentication image, identity authentication is performed according to the face detection result and the certificate detection result to obtain an identity authentication result of the image to be processed.

In addition, various programs and data required by the operations of the apparatus may further be stored in the RAM. The CPU, the ROM and the RAM are connected with one another through the bus. Under the condition that there is the RAM, the ROM is an optional module. The RAM stores executable instructions, or the executable instructions are written in the ROM during running, and execution of the executable instruction enables the processor to execute the corresponding operation of any identity authentication method of the disclosure. An Input/Output (I/O) interface is also connected to the bus. The communication component may be integrated, and may also be arranged to include multiple submodules (for example, multiple IB network cards) connected with the bus.

The following components are connected to the I/O interface: an input part including a keyboard, a mouse and the like; an output part including a Cathode-Ray Tube (CRT), a Liquid Crystal Display (LCD), a speaker and the like; the storage part including a hard disk and the like; and a communication part including a Local Area Network (LAN) card and a network interface card of a modem and the like. The communication part executes communication processing through a network such as the Internet. A driver is also connected to the I/O interface as required. A removable medium, for example, a magnetic disk, an optical disk, a magneto-optical disk and a semiconductor memory, is installed on the driver as required such that a computer program read therefrom is installed in the storage part as required.

It is to be noted that the architecture shown in FIG. 12 is only an optional implementation mode, and the number and types of the components in FIG. 12 may be selected, deleted, added or replaced according to a practical requirement during practice. In terms of arrangement of different functional components, an implementation manner such as separate arrangement or integrated arrangement may also be adopted. For example, the GPU and the CPU may be separately arranged. Or, the GPU may be integrated to the CPU, and the communication unit may be separately arranged and may also be integrated to the CPU or the GPU. All these alternative implementation modes shall fall within the scope of protection disclosed in the disclosure.

Particularly, the processes described above with reference to the flowcharts may be implemented as computer software programs according to the embodiments of the disclosure. For example, an embodiment of the disclosure includes a computer program product, which includes a computer program physically included in a machine-readable medium. The computer program includes program codes configured to execute the methods shown in the flowcharts, and the program codes may include corresponding instructions for correspondingly executing the operations of the identity authentication method provided in any embodiment of the disclosure. In this embodiment, the computer program may be downloaded from the network and installed through the communication part and/or installed from the removable medium. When the computer program is executed by the CPU, the functions limited in the methods of the disclosure are executed.

In addition, an embodiment of the disclosure also provides a computer program, which includes computer instructions that, when being executed in a processor of a device, cause the processor to implement the identity authentication method of any embodiment of the disclosure. In an optional implementation mode, the computer program may be a software product, for example, an SDK. In one or more optional implementation modes, an embodiment of the disclosure also provides a computer program product, which is configured to store computer-readable instructions that, when being executed by a computer, enable the computer to execute the identity authentication method in any possible implementation mode. The computer program product may be implemented through hardware, software or a combination thereof. In an optional example, the computer program product is embodied as a computer storage medium. In another optional example, the computer program product may be embodied as a software product, for example, an SDK.

In one or more optional implementation modes, the embodiment of the disclosure also provides an identity authentication method, as well as a corresponding apparatus, an electronic device, a computer storage medium, a computer program and a computer program product. The method includes that: a first apparatus sends an identity authentication instruction to a second apparatus, the instruction enabling the second apparatus to execute the identity authentication method in any abovementioned possible embodiment; and the first apparatus receives an identity authentication result sent by the second apparatus.

In some embodiments, the identity authentication instruction may be a calling instruction, the first apparatus may instruct the second apparatus in a calling manner to execute the identity authentication method, and correspondingly, the second apparatus, responsive to receiving the calling instruction, may execute the steps and/or flow in any embodiment of the identity authentication method. In addition, an embodiment of the disclosure also provides a computer-readable storage medium, in which computer are program stored, the computer program, when being executed by a processor, cause the processor to implement the identity authentication method of any embodiment of the disclosure.

Each embodiment in the specification is described progressively. Descriptions made in each embodiment focus on differences with the other embodiments and the same or similar parts in each embodiment refer to the other embodiments. The system embodiment substantially corresponds to the method embodiment and thus is described relatively simply, and related parts refer to part of the descriptions about the method embodiment.

The method, apparatus and device of the disclosure may be implemented in various manners. For example, the method, apparatus and device of the disclosure may be implemented through software, hardware, firmware or any combination of the software, the hardware and the firmware. The sequence of the operations of the method is only for description, and the operations of the method of the disclosure are not limited to the sequence described above, unless otherwise specified in another manner In addition, in some embodiments, the disclosure may also be implemented as a program recorded in a recording medium, and the program includes a machine-readable instruction configured to implement the method according to the disclosure. Therefore, the disclosure further covers the recording medium storing the program configured to execute the method according to the disclosure.

The descriptions of the disclosure are made for examples and description and are not exhaustive or intended to limit the disclosure to the disclosed form. Many modifications and variations are apparent to those of ordinary skill in the art. The embodiments are selected and described to describe the principle and practical application of the disclosure better and enable those of ordinary skill in the art to understand the disclosure and further design various embodiments suitable for specific purposes and with various modifications.

1. An identity authentication method, comprising:
performing face detection on an image to be processed through a first neural network to obtain a face detection result, and performing certificate detection on the image to be processed through a second neural network to obtain a certificate detection result;
determining whether the image to be processed is a valid identity authentication image based on the face detection result and the certificate detection result; and
responsive to determining that the image to be processed is the valid identity authentication image, performing identity authentication according to the face detection result and the certificate detection result to obtain an identity authentication result of the image to be processed.

2. The method of claim 1, wherein the valid identity authentication image comprises an image of holding a certificate in hand.

3. The method of claim 1, wherein the face detection result comprises at least one of: a number of one or more faces in the image to be processed or position information of the one or more faces in the image to be processed;
wherein the certificate detection result comprises at least one of: a number of one or more certificates in the image to be processed or position information of the one or more certificates in the image to be processed.

4. The method of claim 1, wherein determining whether the image to be processed is the valid identity authentication image according to the face detection result and the certificate detection result comprises:
determining certificate face information based on the face detection result and the certificate detection result; and
determining whether the image to be processed is the valid identity authentication image based on the certificate face information, the face detection result and the certificate detection result.

5. The method of claim 4, wherein determining the certificate face information based on the face detection result and the certificate detection result comprises:
determining at least one of a number of one or more faces or position information of the one or more faces in a certificate according to position information of one or more faces in the image to be processed in the face detection result and position information of one or more certificates in the image to be processed in the certificate detection result.

6. The method of claim 4, wherein determining whether the image to be processed is the valid identity authentication image based on the certificate face information, the face detection result and the certificate detection result comprises:
responsive to that a number of certificates in the certificate detection result meets a first preset requirement, a number of faces in the face detection result meets a second preset requirement and a number of faces in a certificate in the certificate face information meets a third preset requirement, determining that the image to be processed is the valid identity authentication image.

7. The method of claim 1, wherein performing identity authentication according to the face detection result and the certificate detection result comprises:
determining, based on the face detection result and the certificate detection result, a similarity between a first face in a certificate and a second face outside the certificate in the image to be processed; and
obtaining an identity verification result according to the similarity between the first face and the second face.

8. The method of claim 7, before determining the similarity between the first face in the certificate and the second face outside the certificate in the image to be processed, further comprising:
under a condition that a number of faces in the image to be processed is larger than 2, determining a largest face of the at least two faces outside the certificate in the image to be processed as the second face.

9. The method of claim 7, wherein obtaining the identity verification result according to the similarity between the first face and the second face comprises:
responsive to determining that the similarity between the first face and the second face is greater than a preset threshold, performing text recognition on the certificate to obtain text information of the certificate, the text information comprising at least one of a name or a certificate number; and
obtaining the identity verification result by authenticating the text information based on a user information database.

10. The method of claim 7, further comprising:
responsive to determining that the identity verification result is that identity authentication succeeds, storing user information in a service database, the user information comprising any one or more of: text information, the image to be processed, the image of the second face or feature information of the second face.

11. The method of claim 10, further comprising:
responsive to receiving an identity authentication request, acquiring an image comprising a face to be authenticated;
querying whether there is user information in the service database matched with the image comprising the face to be authenticated; and
determining an authentication result of the face to be authenticated according to a query result.

12. The method of claim 7, wherein performing identity authentication according to the face detection result and the certificate detection result to obtain the identity authentication result of the image to be processed further comprises:
performing anti-spoofing detection according to the face detection result and the certificate detection result to obtain an anti-spoofing detection result; and
determining the identity authentication result of the image to be processed based on the anti-spoofing detection result and the identity verification result.

13. The method of claim 1, wherein performing identity authentication according to the face detection result and the certificate detection result to obtain the identity authentication result of the image to be processed comprises:
performing anti-spoofing detection according to the face detection result and the certificate detection result to obtain an anti-spoofing detection result.

14. The method of claim 13, wherein performing anti-spoofing detection according to the face detection result and the certificate detection result to obtain the anti-spoofing detection result comprises:
acquiring a face region image and a certificate region image from the image to be processed based on the face detection result and the certificate detection result;
performing spoofing clue detection on the image to be processed, the face region image and the certificate region image respectively; and
obtaining the anti-spoofing detection result of the image to be processed based on a result of the spoofing clue detection.

15. The method of claim 14, wherein performing spoofing clue detection on the image to be processed, the face region image and the certificate region image respectively comprises:
performing feature extraction on the image to be processed, the face region image and the certificate region image respectively, to obtain a feature of the image to be processed, a feature of the face region image and a feature of the certificate region image; and
detecting whether the feature of the image to be processed, the feature of the face region image and the feature of the certificate region image comprise spoofing clue information.

16. The method of claim 15, wherein detecting whether the feature of the image to be processed, the feature of the face region image and the feature of the certificate region image comprise the spoofing clue information comprises:
detecting the feature of the image to be processed to determine whether the feature of the image to be processed comprises the spoofing clue information;
detecting the feature of the face region image to determine whether the feature of the face region image comprises the spoofing clue information; and
detecting the feature of the certificate region image to determine whether the feature of the certificate region image comprises the spoofing clue information.

17. The method of claim 15, wherein detecting whether the feature of the image to be processed, the feature of the face region image and the feature of the certificate region image comprise the spoofing clue information comprises:
connecting the feature of the image to be processed, the feature of the face region image and the feature of the certificate region image to obtain a connected feature; and
determining whether the connected feature comprises the spoofing clue information.

18. The method of claim 14, wherein obtaining the anti-spoofing detection result of the image to be processed based on the result of the spoofing clue detection comprises:
responsive to that the result of the spoofing clue detection indicates that each of the image to be processed, the face region image and the certificate region image does not comprise a spoofing clue, determining that the anti-spoofing detection result of the image to be processed is that anti-spoofing detection succeeds; or,
responsive to that the result of the spoofing clue detection indicates that any one or more of the image to be processed, the face region image or the certificate region image comprise a spoofing clue, determining that the anti-spoofing detection result of the image to be processed is that anti-spoofing detection fails.

19. An identity authentication apparatus, comprising:
a processor; and
a memory configured to store instructions executable by the processor,
wherein the processor is configured to:
perform face detection on an image to be processed through a first neural network to obtain a face detection result;
perform certificate detection on the image to be processed through a second neural network to obtain a certificate detection result;
determine whether the image to be processed is a valid identity authentication image based on the face detection result and the certificate detection result; and
responsive to determining that the image to be processed is the valid identity authentication image, perform identity authentication according to the face detection result and the certificate detection result to obtain an identity authentication result of the image to be processed.

20. A non-transitory computer-readable storage medium, having stored therein computer programs that, when being executed by a processor, enable the processor to carry out the following:
performing face detection on an image to be processed through a first neural network to obtain a face detection result, and performing certificate detection on the image to be processed through a second neural network to obtain a certificate detection result;
determining whether the image to be processed is a valid identity authentication image based on the face detection result and the certificate detection result; and
responsive to determining that the image to be processed is the valid identity authentication image, performing identity authentication according to the face detection result and the certificate detection result to obtain an identity authentication result of the image to be processed.
